(19) United States
(12) Patent Application Publication
(10) Pub. No.: US 2026/0091649 A1
(43) Pub. Date: Apr. 2, 2026

(54) RECEIVER DRYER EQUIPPED WITH A HEAT EXCHANGE MODULE AND A VEHICLE THERMAL MANAGEMENT DEVICE INCLUDING THE SAME

(71) Applicants: HYUNDAI MOTOR COMPANY, Seoul (KR); KIA CORPORATION, Seoul (KR)

(72) Inventors: Jong Won Kim, Hwaseong-si (KR); Dae Kyu Han, Hwaseong-si (KR)

(73) Assignees: HYUNDAI MOTOR COMPANY, Seoul (KR); KIA CORPORATION, Seoul (KR)

(21) Appl. No.: 18/974,382

(22) Filed: Dec. 9, 2024

(30) Foreign Application Priority Data
Oct. 2, 2024 (KR) 10-2024-0133499

(51) Int. Cl. B60H 1/32; B60H 1/00

(52) U.S. Cl. CPC B60H 1/3205; B60H 1/00485; B60H 1/323; B60H 2001/00957

(57) ABSTRACT

A receiver dryer includes a heat exchange module connected to a radiator through a coolant line so as to enable coolant passing through the radiator to be supplied to the heat exchange module. The heat exchange module is configured to selectively perform heat exchange between the coolant supplied from the radiator and the refrigerant filling the inside of the housing.

### CROSS-REFERENCE TO RELATED APPLICATION

This application claims, under 35 U.S. C. § 119(a), the benefit of and priority to Korean Patent Application No. 10-2024-0133499, filed on Oct. 2, 2024, the entire contents of which are hereby incorporated herein by reference.

### BACKGROUND

### (a) Technical Field

The present disclosure relates to a receiver dryer equipped with a heat exchange module and a vehicle thermal management device configured to perform thermal management of a vehicle using a heat exchange module.

### (b) Background Art

In general, a vehicle has a thermal management system mounted therein configured to perform overall thermal management of the vehicle. The vehicle thermal management system manages energy required for cooling or heating the vehicle interior and cooling or heating a battery and a component of a power electric (PE) system.

The vehicle thermal management system may be broadly defined as a system including a cooling system and a heating system each configured to perform indoor air conditioning and a component thermal management system using refrigerant and coolant to perform thermal management such as cooling or heating of a battery and parts of a power electronic system.

Normally, the vehicle thermal management system includes a refrigerant system in which a compressor, a condenser, a receiver dryer, an expansion valve, an evaporator, and an accumulator are connected to each other through a refrigerant line.

The above-described components of the refrigerant system are the main components of an air-conditioning system for vehicle interior cooling, and refrigerant sequentially passes through the components while circulating along the refrigerant line.

In addition, the vehicle thermal management system includes a coolant system in which a water pump configured to circulate refrigerant and coolant, a chiller configured to perform heat exchange between refrigerant and coolant, and a radiator configured to perform heat exchange between coolant and air are connected to each other through a coolant line.

Further, the vehicle thermal management system may be operated in a plurality of modes including a heating mode in which heated air is supplied to the vehicle interior for vehicle interior heating, a cooling mode in which cooled air is supplied to the vehicle interior for cooling the vehicle interior (air-conditioning mode), and a dehumidification mode in which air that has exchanged heat with refrigerant is supplied to the vehicle interior for dehumidification of the vehicle interior.

Among the above-described modes, when the thermal management system is operated in the heating mode, refrigerant and an electric heater (for example, a PTC heater) may be used. Further, when the refrigerant temperature is sufficiently high, vehicle interior heating may be performed using high-temperature refrigerant without using the electric heater.

Meanwhile, it is required to provide a technique capable of not only solving a problem related to high temperature and high pressure in a refrigerant system by additionally discharging heat of refrigerant to the outside in the refrigerant system through which the refrigerant circulates, but also improving interior cooling performance, battery cooling performance, and the like by stabilizing the refrigerant system. In addition, it is also required to provide a technique capable of improving efficiency of a vehicle thermal management system including the refrigerant system.

For example, when rapid charging of a battery and vehicle interior cooling are simultaneously performed in an electric vehicle in summer, it is required to provide a heat exchange means capable of effectively discharging heat from the battery through coolant and an additional heat exchange means capable of effectively dissipating heat from refrigerant in order to secure adequate cooling performance.

In addition, a two-pass condenser is used to improve heat pump performance in electric vehicles. However, during interior cooling and battery cooling in the summer, there is a problem in that performance deteriorates due to the formation or occurrence of high pressure in the system.

Additionally, the radiator and the condenser are respectively disposed on the front side and the rear side of the vehicle thermal management system, leading to deterioration in thermal management and refrigerant system performance. Here, a water-cooled heat exchanger is additionally installed in the vehicle thermal management system so as to solve the above-mentioned problem.

In other words, in order to solve the problem of excessive heat load generation, a thermal management system may use a water-cooled heat exchanger (water-cooled condenser) configured to perform heat exchange between refrigerant and coolant for the purpose of securing subcooling and controlling pressure.

Meanwhile, when the water-cooled heat exchanger is used, it is necessary to additionally install related components and, as such, complexity of the system increases, and the structure and configuration of the existing system need to be modified.

The above information disclosed in this Background section is provided only to enhance understanding of the background of the disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with the prior art. It is an object of the present disclosure to provide a receiver dryer and a vehicle thermal management device including the same, configured not only to solve a problem related to high temperature and high pressure in a refrigerant system by additionally discharging heat from refrigerant to the outside in the refrigerant system through which the refrigerant circulates, but also to improve vehicle interior cooling performance, battery cooling performance, and the like by stabilizing the system.

The objects of the present disclosure are not limited to the above-mentioned objects, and other technical objects not mentioned herein should be clearly understood by those having ordinary skill in the art to which the present disclosure pertains (referred to hereinafter as “those having ordinary skill in the art”) from the detailed description of the embodiments.

In one aspect, the present disclosure provides a receiver dryer configured to remove moisture from refrigerant discharged through a condenser and supplied to an inside of a housing, and to separate the refrigerant into liquid refrigerant and gaseous refrigerant at the inside of the housing. The receiver dryer includes a heat exchange module connected to a radiator through a coolant line so as to enable coolant passing through the radiator to be supplied to the heat exchange module. The heat exchange module is configured to selectively perform heat exchange between the coolant supplied from the radiator and the refrigerant inside of the housing.

In an embodiment, the heat exchange module may be coupled to an upper end of the housing or a lower end of the housing.

In another embodiment, the heat exchange module may include a heat exchange part configured to allow the coolant to pass through an inside thereof. In particular, the heat exchange part is configured to perform the heat exchange between the coolant flowing through the inside of the heat exchange part and the refrigerant inside of the housing.

In still another embodiment, the heat exchange part may be a heat exchange pipe having a spirally wound coil spring shape.

In yet another embodiment, the heat exchange module may include a heat exchange part configured to perform the heat exchange between the coolant flowing through an inside of the heat exchange part and the refrigerant inside of the housing. The heat exchange module may further include a bypass flow path part configured to allow the coolant to bypass the heat exchange part without passing through the heat exchange part, and a valve device configured to control a flow of the coolant so as to allow the coolant supplied from the radiator to selectively flow through the heat exchange part or the bypass flow path part.

In still yet another embodiment, the heat exchange module may further include a module case configured to allow the coolant to pass therethrough. The module case may include a coolant inlet formed to allow the coolant passing through the radiator to be introduced thereinto, and a coolant outlet formed to allow the coolant passing through an internal space of the module case to be discharged therethrough.

In a further embodiment, the module case may further include an accommodation part configured to allow an end of the housing to be inserted and coupled thereto.

In another further embodiment, the valve device may include a valve body rotatably disposed in the internal space of the module case. In particular, depending on a rotation position of the valve body, the valve body is configured to cause the coolant inlet to selectively communicate with the heat exchange part or the bypass flow path part such that the coolant flows through a selected one of the heat exchange part or the bypass flow path part. The valve device may further include an actuator configured to rotate the valve body, and a valve controller configured to control an operation of the actuator.

In still another further embodiment, the valve body may have a plurality of blocking walls configured to partition the internal space of the module case. The blocking walls may be configured to cause the coolant inlet to communicate with the heat exchange part at a first rotation position, cause the coolant inlet to communicate with the bypass flow path part at a second rotation position, and simultaneously block the coolant inlet from communicating with the heat exchange part and the bypass flow path part at a third rotation position.

In yet another further embodiment, the valve body may include a central blocking wall located at a central portion of the valve body, the central blocking wall having an open shape on one side of a cross section thereof. The valve body may further include a first blocking wall and a second blocking wall each disposed and extending from the central blocking wall in a radial direction, and a third blocking wall disposed at a position spaced apart from the second blocking wall. The third blocking wall extends from the central blocking wall in the radial direction.

In still yet another further embodiment, the heat exchange part may be disposed at the inside of the housing, and the heat exchange part may have opposite ends (e.g., first and second ends) penetrating the housing and the module case. In particular, the opposite ends are inserted into the internal space of the module case, and one (e.g., the first end) of the opposite ends of the heat exchange part may be an inlet configured to allow the coolant to flow into the heat exchange part, and the inlet (i.e., the first end) is inserted on an inner side of the central blocking wall in the module case, and the other (i.e., the second end) of the opposite ends of the heat exchange part may be an outlet configured to allow the coolant passing through the heat exchange part to be discharged therethrough. The outlet (i.e., the second end) is disposed in a space defined between the first blocking wall and the third blocking wall.

In a still further embodiment, when the valve body is controlled to be in the second rotation position, a space in the internal space of the module case defined between the central blocking wall, the third blocking wall, and the first blocking wall, may serve as the bypass flow path part configured to enable the coolant inlet and the coolant outlet to communicate with each other.

In a yet still further embodiment, when the valve body is controlled to be in the first rotation position, a space in the internal space of the module case defined between the central blocking wall, the first blocking wall, and the second blocking wall, may serve as a flow path space configured to enable the coolant inlet and the inlet of the heat exchange part to communicate with each other.

In an embodiment, when the valve body is controlled to be in the third rotation position, the central blocking wall, the second blocking wall, and the third blocking wall may simultaneously block the coolant inlet from the heat exchange part and the bypass flow path part.

In a yet further embodiment, the heat exchange module may be installed at the inside of the housing, and the coolant supplied from the radiator may be configured to exchange heat with the refrigerant filling the inside of the housing and an outside of the heat exchange module while passing through the heat exchange module inside the housing.

In yet another further embodiment, the heat exchange module may include a heat exchange pipe forming a straight coolant flow path, and heat dissipation fins installed on an outer side of the heat exchange pipe.

In still yet another further embodiment, the heat exchange pipe may be a straight pipe disposed at the inside of the housing and installed in a longitudinal direction of the housing. The heat exchange pipe may have opposite ends respectively located at opposite ends of the housing, and a coolant inlet and a coolant outlet may be respectively disposed in the opposite ends of the heat exchange pipe. Each of the coolant inlet and the coolan outlet may be connected to the coolant line and may be configured to allow the coolant to be introduced thereinto or discharged therethrough.

In a still further embodiment, the housing may include a housing body and caps respectively installed at opposite ends of the housing body, the heat exchange pipe may be installed to vertically pass through an inside of the housing body. The coolant inlet and the coolant outlet may be respectively located at the opposite ends of the heat exchange pipe. The opposite ends of the heat exchange pipe may be respectively inserted into and coupled to the caps, thereby allowing the coolant to vertically pass through the inside of the housing along the heat exchange pipe.

In a yet still further embodiment, the housing may have a plurality of the heat dissipation fins provided at the inside of the housing, the heat dissipation fins being disposed along the heat exchange pipe with a predetermined interval therebetween. The heat exchange pipe may have a filter installed thereon configured to partition the inside of the housing into an upper chamber and a lower chamber, the filter being configured to allow the refrigerant to flow through the filter between the upper chamber and the lower chamber.

In a yet still further embodiment, the heat dissipation fins may be fixedly installed on an outer surface of a pipe member and may be disposed on the outer surface with a predetermined interval therebetween. The pipe member may be coupled to an outer side of the heat exchange pipe such that the heat exchange pipe and the pipe member are in close contact with each other.

In another aspect, the present disclosure provides a vehicle thermal management device including a radiator configured to perform heat exchange between coolant and air, a condenser configured to perform heat exchange between refrigerant and the air, a receiver dryer configured to remove moisture from the refrigerant discharged through the condenser, and to separate the refrigerant into liquid refrigerant and gaseous refrigerant, and a heat exchange module connected to the radiator so as to allow the coolant to move therebetween, the heat exchange module being configured to selectively perform heat exchange between the refrigerant in the receiver dryer and the coolant supplied from the radiator, wherein the heat exchange module may include a heat exchange part disposed inside the receiver dryer, the heat exchange part being configured to perform the heat exchange between the coolant and the refrigerant.

In an embodiment, the heat exchange module may be coupled to an upper end of the receiver dryer or a lower end thereof.

In another embodiment, the heat exchange module may include the heat exchange part configured to perform the heat exchange between the coolant flowing through an inside of the heat exchange part and the refrigerant in the receiver dryer, a bypass flow path part configured to allow the coolant to bypass the heat exchange part without passing through the heat exchange part, and a valve device configured to control a flow of the coolant so as to allow the coolant supplied from the radiator to selectively flow through the heat exchange part or the bypass flow path part.

In still another embodiment, the heat exchange module may further include a module case configured to allow the coolant to pass therethrough, wherein the module case may include a coolant inlet formed to allow the coolant passing through the radiator to be introduced thereinto, and a coolant outlet formed to allow the coolant passing through an internal space of the module case to be discharged therethrough.

In yet another embodiment, the valve device may further include a valve body rotatably disposed in the internal space of the module case, the valve body being configured to cause the coolant inlet to selectively communicate with, depending on a rotation position of the valve body, the heat exchange part or the bypass flow path part such that the coolant flows through the selected heat exchange part or bypass flow path part, an actuator configured to rotate the valve body, and a valve controller configured to control an operation of the actuator.

In still yet another embodiment, the valve body may have a plurality of blocking walls configured to partition the internal space of the module case, wherein the blocking walls may be configured to cause the coolant inlet to communicate with the heat exchange part at a first rotation position, cause the coolant inlet to communicate with the bypass flow path part at a second rotation position, and simultaneously block the coolant inlet from communicating with the heat exchange part and the bypass flow path part at a third rotation position.

In a further embodiment, the heat exchange module may include a heat exchange pipe forming a straight coolant flow path and heat dissipation fins installed on an outer side of the heat exchange pipe, wherein the heat exchange pipe and the heat dissipation fins may form the heat exchange part.

In another further embodiment, the heat exchange pipe may be a straight pipe disposed at an inside of the housing and installed in a longitudinal direction of the housing, and the heat exchange pipe may have opposite ends respectively located at opposite ends of the housing, and coolant inlets/outlets may be respectively disposed in the opposite ends of the heat exchange pipe, wherein each of the coolant inlets/outlets may be connected to the coolant line and may be configured to allow the coolant to be introduced thereinto or discharged therethrough.

In still another further embodiment, the housing may include a housing body and caps respectively installed at opposite ends of the housing body, the heat exchange pipe may be installed to vertically pass through an inside of the housing body, and the coolant inlets/outlets may be respectively located at the opposite ends of the heat exchange pipe, and the opposite ends of the heat exchange pipe may be respectively inserted into and coupled to the caps, thereby allowing the coolant to vertically pass through the inside of the housing along the heat exchange pipe.

In yet another further embodiment, the housing may have a plurality of the heat dissipation fins provided at the inside of the housing, the heat dissipation fins being disposed along the heat exchange pipe with a predetermined interval therebetween, and the heat exchange pipe may have a filter installed thereon and configured to partition the inside of the housing into an upper chamber and a lower chamber, the filter being configured to allow the refrigerant to flow through the filter between the upper chamber and the lower chamber.

In still yet another further embodiment, the heat dissipation fins may be fixedly installed on an outer surface of a pipe member and may be disposed on the outer surface with a predetermined interval therebetween, and the pipe member may be coupled to an outer side of the heat exchange pipe such that the heat exchange pipe and the pipe member are in close contact with each other.

Other aspects and embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure are described below in detail with reference to certain embodiments thereof illustrated in the accompanying drawings which are given hereinbelow by way of illustration only, and thus do not limit the present disclosure, and wherein:

FIG. 1 is a diagram showing a configuration of a thermal management device according to an embodiment of the present disclosure;

FIG. 2 is a diagram showing a connection state of a receiver dryer equipped with a heat exchange module and a condenser in the thermal management device according to an embodiment of the present disclosure;

FIG. 3 is a diagram showing a heat exchange part of the heat exchange module, a module case thereof, and the receiver dryer in a state of being separated from each other in an embodiment of the present disclosure;

FIG. 4 is a cross-sectional view showing a connection state of the condenser, the receiver dryer, and the heat exchange module in an embodiment of the present disclosure;

FIG. 5 is a cross-sectional view showing a connection state of the condenser, the receiver dryer, and the heat exchange module in another embodiment of the present disclosure;

FIG. 6 is a plan view of the module case when viewed in the direction indicated by an arrow “A” in FIG. 3;

FIG. 7 is a cross-sectional view taken along line “B-B” in FIG. 3;

FIG. 8 is a cross-sectional view taken along line “C-C” in FIG. 6;

FIGS. 9-11 are diagrams each showing a control state of a valve device and a coolant flow state in the operation mode of the heat exchange module in an embodiment of the present disclosure;

FIGS. 12-14 are diagrams each showing a flow of coolant and refrigerant in the operation mode of the thermal management device;

FIG. 15 is a diagram schematically showing a receiver dryer and a thermal management device including the same according to still another embodiment of the present disclosure;

FIG. 16 is a cross-sectional view of an internal configuration of the receiver dryer shown in FIG. 15;

FIG. 17 is an exploded cross-sectional view of components of the receiver dryer shown in FIG. 16;

FIGS. 18 and 19 are diagrams each showing a flow of coolant and refrigerant in the operation mode of the thermal management device shown in FIG. 15;

FIG. 20 is a diagram showing an example in which coolant is introduced through a first coolant inlet/outlet and then is discharged through a second coolant inlet/outlet according to still yet another embodiment of the present disclosure;

FIG. 21 is a diagram showing the temperature while refrigerant and coolant pass through the receiver dryer in the embodiment of FIG. 20;

FIG. 22 is a diagram showing an example in which coolant is introduced through a second coolant inlet/outlet and then is discharged through a first coolant inlet/outlet according to still yet another further embodiment of the present disclosure.

FIG. 23 is a diagram showing the temperature while refrigerant and coolant pass through the receiver dryer in the embodiment of FIG. 22.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings. DETAILED DESCRIPTION

Hereinafter, embodiments of the present disclosure are described in detail with reference to the attached drawings. Specific structural or functional descriptions given in connection with the embodiments of the present disclosure are merely illustrative for the purpose of describing embodiments according to the concepts of the present disclosure. The embodiments according to the concepts of the present disclosure may be implemented in various forms. Further, it should be understood that the present description is not intended to limit the disclosure to the described embodiments. On the contrary, the disclosure is intended to cover not only the embodiments described herein, but also various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, for example, “between” and “directly between” or “adjacent to” and “directly adjacent to”, should be interpreted in the same manner.

The same reference numerals represent the same components throughout the specification. Additionally, the terms in the specification are used merely to describe the embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described. When a component, device, element, or the like of the present disclosure is described as having a purpose or performing an operation, function, or the like, the component, device, or element should be considered herein as being “configured to” meet that purpose or perform that operation or function.

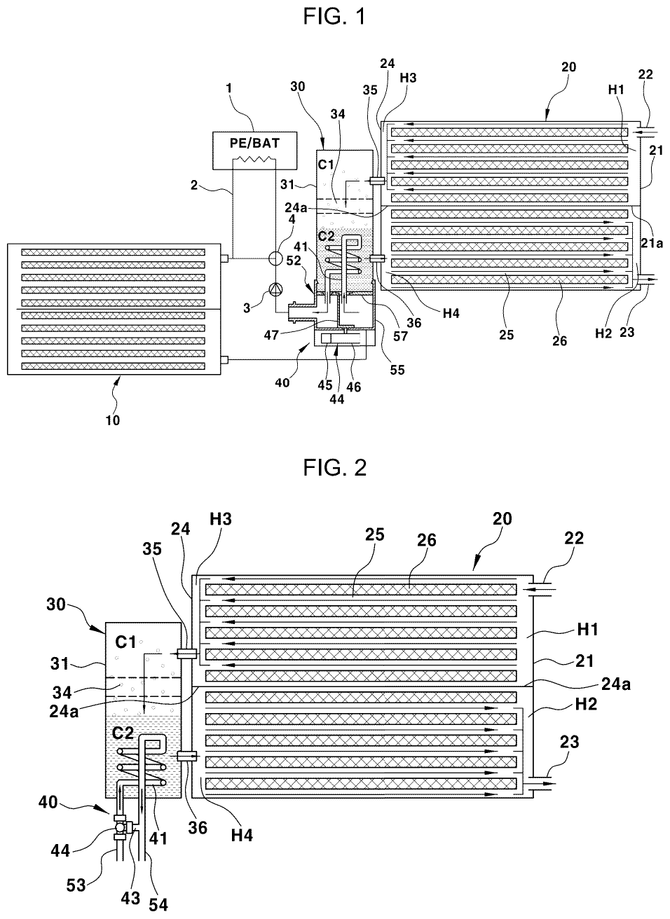

FIG. 1 is a diagram showing a configuration of a thermal management device according to an embodiment of the present disclosure, and FIG. 2 is a diagram showing a connection state of a receiver dryer (e.g., a receiver drier) equipped with a heat exchange module and a condenser in the thermal management device according to an embodiment of the present disclosure.

As shown in the drawing, the thermal management device according to an embodiment of the present disclosure includes a radiator 10 configured to perform heat exchange between coolant passing through the inside of the radiator and air passing through or along the periphery thereof and a condenser 20 configured to perform heat exchange between refrigerant passing through the inside of the condenser and air passing through or along the periphery thereof. The thermal management device may further include a receiver dryer 30 (e.g., receiver drier 30) configured to remove moisture from the refrigerant passing through the condenser 20, and a heat exchange module 40 configured to selectively perform heat exchange between the refrigerant of the receiver dryer 30 and the coolant discharged from the radiator 10.

The radiator 10 of the thermal management device is a heat exchanger configured to perform heat exchange between coolant and air in a component thermal management system and a cooling system and a heating system each configured to perform indoor air conditioning. The component thermal management system may be configured to perform thermal management such as cooling and heating for a batter or power electric (PE) system 1.

To this end, a coolant line 2 of the vehicle thermal management system including the component thermal management system is connected to the radiator 10, such that, coolant that has cooled the battery or power electric system 1 in the thermal management system may be supplied to the radiator 10 through the coolant line 2, and the coolant may pass through the inside of the radiator 10.

The radiator 10 constitutes a cooling module of a vehicle with a cooling fan. In a typical cooling module, the radiator performs heat exchange with the coolant passing through the inside of the radiator 10 while outside air suctioned by the cooling fan passes through or along the periphery of the radiator 10.

The component thermal management system includes at least one of a battery thermal management system and a PE thermal management system each configured to circulate coolant. The battery thermal management system is configured to control the temperature of a battery so as to manage the heat of a battery and includes a battery coolant passage provided in the battery and a battery coolant line connected to the battery coolant passage.

In the battery thermal management system, coolant supplied by a water pump 3 circulates along the battery coolant line and passes through the battery coolant passage, and cools or heats the battery while the coolant passes through the battery coolant passage. In the following description, the coolant of the battery thermal management system is referred to as “battery coolant”.

The PE thermal management system performs temperature control and thermal management for a power electronic system (hereinafter referred to as “PE system”) and includes a PE coolant passage provided in a device or a component of the PE system and a PE coolant line connected to the PE coolant passage.

In the PE thermal management system, coolant supplied by the water pump 3 passes through the PE coolant passage while circulating along the PE coolant line. Further, the coolant cools or heats the PE system while passing through the PE coolant passage. In the following description, the coolant of the PE thermal management system is referred to as “PE coolant”.

The PE system may include an inverter and a motor mounted on an electric vehicle, and more specifically, may include a front motor and a rear motor each serving as a driving device, a front inverter adapted to drive and control the front motor, and a rear inverter adapted to drive and control the rear motor.

Here, the front motor is a motor connected to front wheels of a vehicle so as to be able to transmit power to the front wheels, thereby driving the front wheels. The rear motor is a motor connected to the rear wheels of a vehicle so as to be able to transmit power to the rear wheels, thereby driving the rear wheels.

A connection relationship between the battery or PE system 1 and the radiator 10 is shown in FIG. 1. The coolant line 2 (battery coolant line or PE coolant line) of the thermal management system, which is connected to the battery or PE system 1, may be connected to a coolant inlet of the radiator 10. The coolant line 2 is also connected to a coolant outlet 54 of the heat exchange module 40 described below.

The water pump 3 in FIG. 1 is provided to suction coolant from the coolant line 2 and discharge the same such that the coolant may circulate along the coolant line 2 in the vehicle thermal management system including the component thermal management system.

Although not shown in FIG. 1, a reservoir tank in which coolant is stored may be disposed at a front position of the water pump 3. In this case, the water pump 3 may suction coolant from the reservoir tank and discharge the coolant.

In FIG. 1, reference numeral “4” is a flow control valve configured to control a flow of coolant in the vehicle thermal management system including the component thermal management system. As shown in the drawing, the flow control valve 4 may be provided to control the flow of coolant to the radiator 10 in the thermal management system.

In the thermal management system, depending on the opening state of the flow control valve 4, the coolant may be selectively supplied to the radiator 10, and the coolant may selectively pass through the radiator 10. In addition, in the coolant circulating along the coolant line 2 of the thermal management system, the amount of coolant distributed to the radiator 10 may be controlled.

A separate coolant line may branch from the coolant line 2 of the thermal management system and may be connected to the coolant inlet side of the radiator 10. The flow control valve 4 may be installed at a position where the separate coolant line branches from the coolant line 2 of the thermal management system. Here, the flow control valve 4 may be an electronic three-way valve, the opening state of which is controlled by a controller.

Referring to FIG. 1, the coolant line 2 of the thermal management system, which is connected from the battery or PE system 1, is connected to the coolant inlet of the radiator 10 The coolant outlet of the radiator 10 is connected to a coolant inlet 53 of the heat exchange module 40 through the coolant line 2.

The water pump 3 in FIG. 1 may be a water pump of the battery thermal management system or the PE thermal management system. The radiator 10 may be a radiator configured to allow the PE coolant line of the PE thermal management system to be connected thereto so as to perform heat exchange between the PE coolant and the outside air, or may be a radiator configured to allow the battery coolant line of the battery thermal management system to be connected thereto so as to perform heat exchange between the battery coolant and the outside air.

When the component thermal management system includes both the battery thermal management system and the PE thermal management system, the battery thermal management system and the PE thermal management system may have respective coolant system configurations allowing coolant to circulate therethrough. In this case, the water pumps 3 may be respectively installed on the battery coolant line of the battery thermal management system and the PE coolant line of the PE thermal management system such that coolant circulates along the battery coolant line and the PE coolant line.

In addition, although not shown in the drawing, a chiller expansion valve and a chiller may be installed on a chiller refrigerant line branching from a refrigerant line of a heating and cooling system, and a battery coolant line may be connected to the chiller such that the battery coolant of the battery thermal management system passes through the chiller. Further, the PE coolant line may be connected to the chiller such that the PE coolant of the PE thermal management system passes through the chiller.

In this configuration, the refrigerant expanded to a low-temperature and low-pressure state while passing through the chiller expansion valve, the battery coolant circulating along the battery coolant line between the battery coolant passage and the chiller, and the PE coolant circulating along the PE coolant line between the PE coolant passage and the chiller pass through the chiller. Therefore, heat exchange between the refrigerant, the battery coolant, and the PE coolant may be performed in the chiller.

In this case, the coolant line 2 connected to the coolant inlet of the radiator 10 in FIG. 1 may be a separate battery coolant line branching from the battery coolant line of the battery thermal management system via the flow control valve 4 or a separate PE coolant line branching from the PE coolant line of the PE thermal management system via the flow control valve 4.

In the thermal management device shown in FIG. 1, the condenser 20 is a heat exchanger configured to perform heat exchange between coolant passing through the inside of condenser and air passing through the periphery thereof. Air that exchanges heat with the refrigerant in the condenser 20 may be outside air suctioned by the cooling fan configured to pass through or along the periphery of the condenser 20.

The condenser 20 may be an external condenser 20 (outdoor heat exchanger) configured to perform heat exchange between refrigerant flowing through the inside of condenser and outside air suctioned by the cooling fan. An expansion valve capable of selectively expanding refrigerant may be installed on a refrigerant line connected to the side of a refrigerant inlet 22 of the condenser 20.

The condenser 20 may serve as a condenser and a radiator dissipating heat of the refrigerant to the outside air in the cooling mode (dissipates heat to the outside air, “heat dissipation to the outside air”). In the heating mode, the condenser 20 may serve as an evaporator configured to allow the refrigerant to receive the heat of the outside air (absorbs heat from the outside air, “outside air heat absorption”).

When the refrigerant is expanded to a low-temperature and low-pressure state while passing through the expansion valve installed on the refrigerant line on the refrigerant inlet 22 side and then passes through the condenser 20, the low-temperature refrigerant passing through the inside of the condenser 20 receives heat from the outside air passing through the periphery of the condenser 20 (“outside air heat absorption”). At this time, the condenser 20 serves as an evaporator.

On the other hand, when the expansion valve allows the refrigerant to pass therethrough without expanding the refrigerant, the refrigerant may dissipate heat to the outside air passing through the periphery of the condenser 20 while the refrigerant passes through the inside of the condenser 20 (“outside air heat absorption”). At this time, the condenser 20 serves as a condenser configured to condense the refrigerant.

A description is given as to a configuration of the condenser. The condenser 20 includes a first header tank 21, a second header tank 24, a tube 25, and a fin 26. The first header tank 21 and the second header tank 24 are arranged in parallel so as to be spaced apart from each other a predetermined distance. Each of the first header tank 21 and the second header tank 24 has an internal space formed therein configured to allow refrigerant to pass therethrough.

In addition, the tube 25 through which refrigerant flows horizontally connects the first header tank 21 to the second header tank 24, the first and second header tanks being spaced apart from each other. The tube 25 has opposite ends (e.g., a first end and a second end) respectively fixed to the first header tank 21 and the second header tank 24. An internal space of the tube 25, which serves as a refrigerant flow path, communicates with the internal spaces of the first header tank 21 and the second header tank 24, thereby enabling the refrigerant to flow through the internal spaces of the first header 21, the tube 25, and the second header 24.

Further, in the condenser 20, a plurality of tubes 25 are installed in parallel with each other in state of being vertically spaced apart from each other between the first header tank 21 and the second header tank 24. Accordingly, the refrigerant may flow between the first header tank 21 and the second header tank 24 through the plurality of tubes 25 installed in parallel with each other. In this structure, the fins 26 are respectively interposed between the plurality of tubes 25 so as to increase a heat transfer area.

A two-pass condenser is shown in FIG. 1. A refrigerant flow pass or path inside the condenser 20 is shown by an arrow. The first header tank 21 of the condenser 20 is equipped with the refrigerant inlet 22 through which refrigerant is introduced, and a refrigerant outlet 23 through which refrigerant is discharged. Partition walls 21a and 24a are installed in the header tanks 21 and 24 so as to partition the internal space into upper chambers H1 and H3 and lower chambers H2 and H4.

The receiver dryer 30 is connected to the condenser 20. Here, an internal space of a housing 31 of the receiver dryer 30 is partitioned into an upper chamber C1 and a lower chamber C2 by a filter 34 including a strainer and a desiccant.

The refrigerant inlet 22 of the condenser 20 is installed in the upper chamber H1 partitioned by the partition wall 21a in the first header tank 21. The refrigerant outlet 23 of the condenser 20 is installed in the lower chamber H2 of the first header tank 21.

In the condenser 20, the upper chamber H3 of the second header tank 24 is connected to the upper chamber C1 of the receiver dryer 30 through a connection passage 35, thereby enabling the refrigerant to flow through the upper chamber H3 and the upper chamber C1 with the connection passage 35 interposed therebetween. The lower chamber H4 of the second header tank 24 is connected to the lower chamber C2 of the receiver dryer 30 through another connection passage 36, thereby enabling the refrigerant to flow through the lower chamber H4 and the lower chamber C2 with the connection passage 36 interposed therebetween.

In this structure, when the refrigerant is introduced through the refrigerant inlet 22 of the condenser 20, the refrigerant flows horizontally from the upper chamber H1 of the first header tank 21 to the upper chamber H3 of the second header tank 24 through the tube 25, thereby forming a first refrigerant flow pass.

In addition, the refrigerant that has moved to the upper chamber H3 of the second header tank 24 moves to the upper chamber C1 of the receiver dryer 30 through the connection passage 35. Thereafter, the refrigerant passes through the strainer and desiccant of the filter 34 and moves to the lower chamber C2 of the receiver dryer 30.

The refrigerant that has moved to the lower chamber C2 of the receiver dryer 30 moves to the lower chamber H4 of the second header tank 24 through the connection passage 36, and the refrigerant that has moved to the lower chamber H4 of the second header tank 24 moves horizontally to the lower chamber H2 of the first header tank 21 through the tube 25, thereby forming a second refrigerant flow pass. In this manner, the refrigerant that has moved to the first header tank 21 is discharged to the outside through the refrigerant outlet 23 of the condenser 20.

As shown in FIG. 1, the condenser 20 has two refrigerant flow passes formed therein, but the present disclosure is not limited thereto. For example, it is also possible to provide a three-pass condenser having three refrigerant flow passes formed therein or a four-pass condenser having four refrigerant flow passes formed therein.

In the present disclosure, the refrigerant flowing into the first header tank 21 through the refrigerant inlet 22 of the condenser 20 may be in a high-temperature and high-pressure state. The refrigerant discharged from the first header tank 21 through the refrigerant outlet 23 of the condenser 20 may be in the low-temperature and high-pressure state.

While the high-temperature refrigerant flowing into the first header tank 21 through the refrigerant inlet 22 moves to the second header tank 24 and then passes through the receiver dryer 30, the refrigerant is cooled by coolant passing through the heat exchange module 40. The coolant passing through the heat exchange module 40 may be discharged from the radiator 10. The low-temperature refrigerant that has completed heat exchange with the coolant moves from the second header tank 24 to the first header tank 21 and then is discharged through the refrigerant outlet 23.

In the present disclosure, the receiver dryer 30 performs a function of removing moisture from the refrigerant using a desiccant and also performs a function of separating the refrigerant inside the housing 31 into gaseous refrigerant and liquid refrigerant.

In the housing 31 of the receiver dryer 30, the lower chamber C2 is mainly, primarily, or mostly filled with liquid refrigerant. The heat exchange module 40 for heat exchange with coolant may be installed in the lower chamber C2 of the receiver dryer 30. Accordingly, heat exchange may be performed between the coolant passing through the heat exchange module 40 and the liquid refrigerant inside the receiver dryer 30.

The two-pass condenser 20 as shown in FIG. 1 is advantageous when a heat pump is operated in the heating mode. However, in the case of the two-pass condenser 20, it is difficult to sufficiently dissipate heat due to a short pass during interior cooling in the summer. Accordingly, there is a disadvantage in that it is difficult to solve a system high pressure problem and to secure sufficient subcooling.

When the heat pump is in operation, refrigerant that has been expanded to the low-temperature and low-pressure state while passing through the expansion valve is introduced into the inside of the condenser 20 through the refrigerant inlet 22. Thereafter, while passing through the interior of the condenser 20, the refrigerant receives heat from the outside air passing through or along the periphery of the condenser 20.

During heating, refrigerant passing through the inside of the condenser after being supplied to the condenser 20 without being expanded by the expansion valve needs to dissipate heat to the outside air passing through the periphery of the condenser. However, in the two-pass condenser having a short pass as shown in FIG. 1, it is difficult to solve the high pressure problem and to secure sufficient subcooling.

Accordingly, the present disclosure provides the heat exchange module 40 including a heat exchange part 41 installed in the receiver dryer 30 so as to allow the low-temperature coolant that has passed through the radiator 10 to pass through the heat exchange part 41, thereby performing heat exchange between the refrigerant inside the receiver dryer 30 and the coolant in the heat exchange part 41.

In this manner, additional heat dissipation is performed to dissipate the heat of the high-temperature and high-pressure refrigerant to the coolant, thereby making it possible not only to solve the problem of high system pressure, but also to secure additional subcooling through the additional heat dissipation.

FIG. 2 is a diagram schematically showing a connection relationship between the condenser, the receiver dryer, and the heat exchange module in the thermal management device according to an embodiment of the present disclosure. In FIG. 2, a valve device 44 of the heat exchange module 40 is schematically shown as a three-way valve. In the example of FIG. 2, reference numeral “43” may refer to a bypass flow path part.

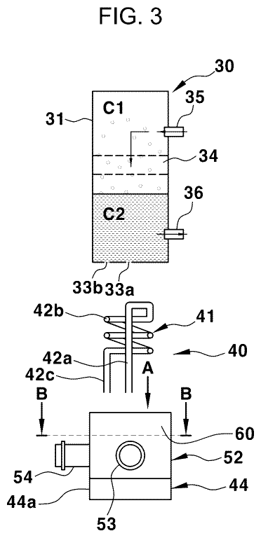

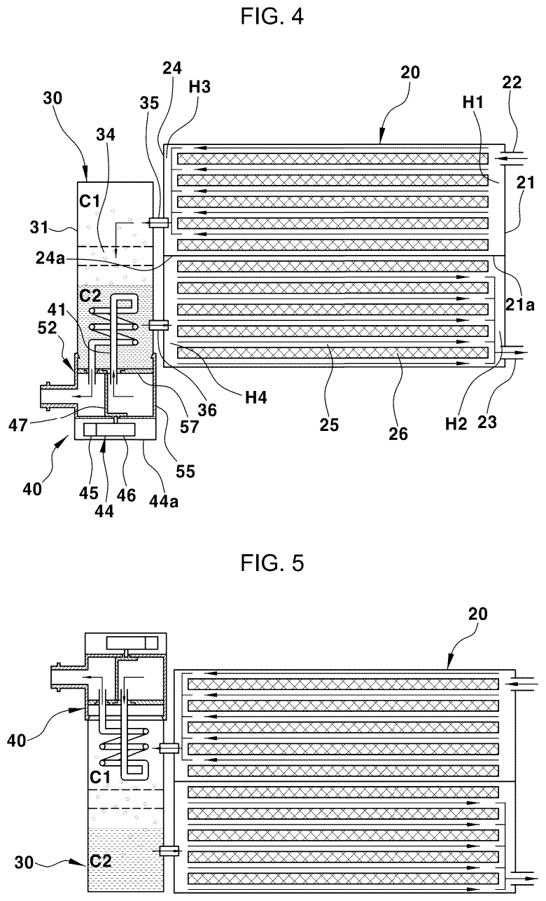

FIG. 3 is a diagram showing the heat exchange part of the heat exchange module, the module case of the heat exchange module, and the receiver dryer in a state of being separated from each other in an embodiment of the present disclosure. As shown in FIG. 3, an actuator case (reference numeral “44a” in FIGS. 3, 4, and 8) in which an actuator 46 (reference numeral “46” in FIG. 4) of the valve device 44 is housed is coupled to a lower portion of a module case 52.

FIG. 4 is a cross-sectional view showing a connection state of the condenser, the receiver dryer, and the heat exchange module in an embodiment of the present disclosure. Further, FIG. 5 is a cross-sectional view showing a connection state of the condenser, the receiver dryer, and the heat exchange module according to another embodiment of the present disclosure.

As shown in FIGS. 4 and 5, the heat exchange module 40 may be installed in the receiver dryer 30. The coolant passing through the heat exchange module 40 exchanges heat with the refrigerant inside the receiver dryer while passing through the inside of the housing 31 of the receiver dryer 30.

Specifically, the heat exchange module 40 includes the heat exchange part 41 provided to allow coolant discharged from the radiator 10 to pass therethrough and configured to perform heat exchange between the coolant and the refrigerant inside the receiver dryer 30. The heat exchange module 40 also includes the bypass flow path part (reference numeral “43” in FIGS. 2, 7, and 10) configured to allow the coolant discharged from the radiator 10 to bypass the heat exchange part 41 such that the coolant does not pass through the heat exchange part. The heat exchange module also includes the valve device 44 configured to control a flow of the coolant so as to allow the coolant discharged from the radiator 10 to selectively flow through the heat exchange part 41 or the bypass flow path part 43.

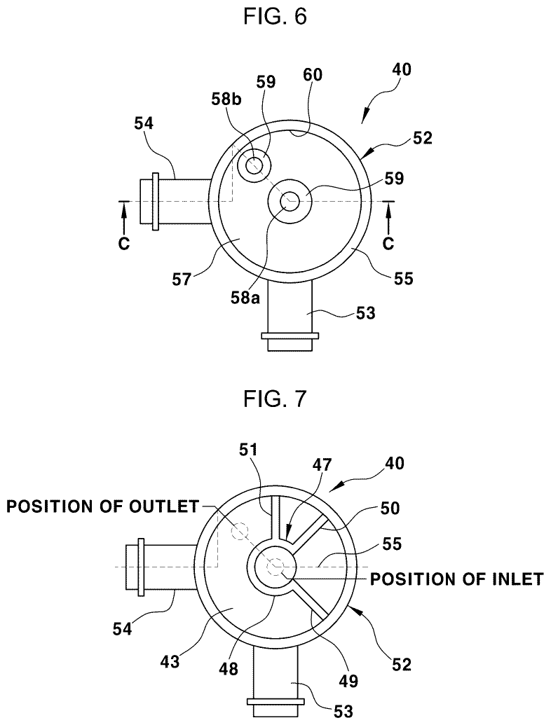

In an embodiment of the present disclosure, the heat exchange module 40 further includes the module case 52 through which coolant passes. The module case 52 includes a coolant inlet (reference numeral “53” in FIG. 6) through which the coolant discharged from the radiator 10 is introduced, and a coolant outlet 54 through which the coolant that has selectively passed through one of the heat exchange part 41 and the bypass flow path part 43 is discharged. The coolant inlet 53 is formed on one side of the module case 52, and the coolant outlet 54 is formed on the other side of the module case 52.

The coolant inlet 53 of the heat exchange module 40 is connected to the coolant outlet of the radiator 10 through the coolant line. The coolant outlet 54 of the heat exchange module 40 is connected to the battery or PE system 1 through the coolant line 2.

Accordingly, the coolant discharged from the coolant outlet 54 of the heat exchange module 40 may flow into the battery or PE system 1, specifically, into the battery coolant passage or the PE coolant passage of the component thermal management system.

In addition, the bypass flow path part 43 and a valve body 47 of the valve device 44 are located inside the module case 52. The heat exchange part 41 is disposed outside the module case 52, and the coolant flow path of the heat exchange part 41 and the internal space of the module case 52 communicate with each other in a state in which opposite ends (e.g., first and second ends) of the heat exchange part 41 are inserted into the inside of the module case 52, thereby enabling the coolant to flow therebetween.

FIGS. 4 and 5 are cross-sectional views each showing the receiver dryer 30, the heat exchange part 41 and the valve device 44 of the heat exchange module 40, and the module case 52. In addition, FIG. 4 shows an embodiment in which the heat exchange module 40 is mounted on the lower end of the receiver dryer 30, and FIG. 5 shows an embodiment in which the heat exchange module 40 is mounted on the upper end of the receiver dryer 30.

As shown in the drawings, the module case 52 of the heat exchange module 40 includes, in addition to the coolant inlet 53 and the coolant outlet 54, a case body 55 having an internal space formed therein, the internal space having a predetermined volume, a cover 57 coupled to one side of the case body 55 and configured to seal the internal space of the case body, and an accommodation part 60 having the end of the receiver dryer 30 coupled thereto.

The case body 55 is formed to have a cylindrical shape with a predetermined diameter. Here, one end of the cylindrical shape is formed to have or includes a closed structure, and the other end thereof is formed to have or includes an open structure so as to allow the end of the receiver dryer 30 to be inserted thereinto.

In this case, the cover 57 is coupled to the open end of the case body 55 so as to be located therein. For example, the cover 57 is coupled to the inside of the other end of the case body 55. Here, the cover 57 is coupled to the case body 55 so as to be horizontally disposed at the inner position of the case body 55 in a state of being spaced apart from the end position of the other end of the case body 55 by a predetermined distance and depth.

Accordingly, in the module case 52, the space defined between the inner side of the end of the case body 55 in which the cover 57 is installed and the outer side of the cover 57 becomes the accommodation part 60 configured to allow the end of the receiver dryer 30 to be insertably coupled thereto.

In this case, the end of the case body 55 forms the side surface of the accommodation part 60, and the outer surface of the cover 57 becomes the bottom surface of the accommodation part 60 on which the end of the receiver dryer 30 is seated and supported in a contact state.

In addition, a hook coupling structure may be provided to couple the receiver dryer 30 to the module case 52 so as to prevent separation therebetween when the receiver dryer 30 is inserted into the accommodation part 60.

In order to achieve stable coupling between the receiver dryer 30 and the accommodation part 60, a coupling protrusion having a hook shape in cross section may be formed, from a tip portion of the case body 55, along at least a part or the entire circumferential section of the case body 55 forming the accommodation portion 60, for example, along the entire circumferential section of the tip portion of the case body 55.

In addition, a coupling groove may be formed at a position of the outer circumferential surface of the receiver dryer 30 inserted into the accommodation part 60, in which the position corresponds to the position of the coupling protrusion. In this manner, the coupling groove allows the coupling protrusion to be inserted thereinto and caught therein.

Accordingly, when the receiver dryer 30 is simply inserted into the accommodation part 60 of the module case 52, the coupling protrusion is inserted into the coupling groove. In this state, the receiver dryer 30 may maintain a constant coupled state without being separated from the accommodation part 60 of the module case 52 by coupling force between the coupling protrusion and the coupling groove.

The module case 52 configured as described above has an actuator case 44a integrally coupled thereto. The actuator 46 of the valve device 44 is accommodated in the actuator case 44a.

In the embodiment of FIG. 4, the actuator case 44a and the actuator 46 accommodated therein are disposed on the lower side of the module case 52. In the embodiment of FIG. 5, the actuator case 44a and the actuator 46 accommodated therein are disposed on the upper side of the module case 52.

Although not shown in detail in the drawings, examples of a method of fixing the module case 52 (case body) to the actuator case 44a may include a screw fastening method, a fitting method, a welding method, a locking method using a protrusion (including a hook) and a hooking groove, and the like.

In addition, the accommodation part 60 is formed on one side of the module case 52. Here, as described, at least a part of the receiver dryer 30 is inserted into and coupled to the accommodation part. In the embodiment of FIG. 4, the accommodation part 60 is formed on the upper side of the module case 52. In the embodiment of FIG. 5, the accommodation part 60 is formed on the lower side of the module case 52.

In the embodiment of FIG. 4, the heat exchange module 40 is mounted on the lower end of the receiver dryer 30, and the cover 57 is coupled to the case body 55 in a state of being positioned inside the upper end of the case body 55. In addition, in the embodiment of FIG. 4, the space defined between the inner side of the upper end of the case body 55 and the outer side of the cover 57 serves as the accommodation part 60 having the lower end of the receiver dryer 30 inserted thereinto.

In this case, each of the upper end of the case body 55 and the accommodation part 60 has an open structure in the upward direction. Further, the lower end of the receiver dryer is inserted through the upper opening of the case body 55. The lower end of the receiver dryer 30 and the upper surface of the cover 57 may be tightly coupled to each other.

In addition, in the embodiment of FIG. 4, the heat exchange part 41 is inserted into and placed in the lower chamber C2 of the receiver dryer 30 in a state in which the opposite ends (i.e., the first and second ends) of the heat exchange part 41 (heat exchange pipe) penetrate the cover 57 and are coupled thereto.

In this manner, when the heat exchange part 41 is coupled to the cover 57, heat exchange is performed between the liquid refrigerant filling the lower chamber C2 of the receiver dryer 30 and the coolant flowing through the inside of the heat exchange part 41 of the heat exchange module 40. In this case, the refrigerant may be cooled by the coolant while the coolant receives heat from the refrigerant.

Furthermore, in the embodiment of FIG. 4, the actuator case 44a is integrally coupled to the lower side of the case body 55, and the actuator 46 of the valve device 44 is accommodated in the actuator case 44a.

In addition, the valve device 44 may have a separate valve controller 45 configured to control the operation of the actuator 46. The valve controller 45 may also be accommodated in the actuator case 44a.

In the embodiment of FIG. 5, the heat exchange module 40 is mounted on the upper end of the receiver dryer 30, and the cover is coupled to the inside of the lower end of the case body so as to be located therein. In the embodiment of FIG. 5, the heat exchange module 40 has a configuration in which the upper and lower portions are inverted as compared with the heat exchange module 40 in FIG. 4, for example, a configuration in which the upper portion of the heat exchange module in FIG. 4 becomes the lower portion of the heat exchange module in FIG. 5, and the lower portion of the heat exchange module in FIG. 4 becomes the upper portion of the heat exchange module in FIG. 5. Other configurations of the heat exchange modules in FIGS. 4 and 5 may be the same.

In the embodiment of FIG. 5, a space defined between the inner side of the lower end of the case body and the outer side of the cover becomes an accommodation portion in which the lower end of the receiver dryer 30 is placed. In this case, the lower end of the case body and the accommodation portion have an open structure in the downward direction.

The upper end of the receiver dryer is inserted through the lower opening of the case body, and the upper end of the receiver dryer 30 and the lower end of the cover are tightly coupled to each other.

In addition, in the embodiment of FIG. 5, the heat exchange part (heat exchange pipe) is inserted into and disposed in the upper chamber of the receiver dryer 30 in a state in which the opposite ends of the heat exchange part penetrate the cover and are coupled thereto.

When the heat exchange part is coupled to the cover, heat exchange is performed between gaseous refrigerant filling the upper chamber C1 of the receiver dryer 30 and coolant flowing through the inside of the heat exchange part of the heat exchange module 40. In this case, when the coolant receives the heat from the refrigerant, the refrigerant may be cooled by the coolant.

Further, in the embodiment of FIG. 5, the actuator case is integrally coupled to the upper side of the case body, and the actuator of the valve device is accommodated in the actuator case. Additionally, the valve device may have a separate valve controller configured to control the operation of the actuator, and the valve controller may also be accommodated in the actuator case.

In addition, in the embodiments of FIGS. 4 and 5, the housing 31 of the receiver dryer 30 may be formed to have a cylindrical shape with a predetermined diameter and may extend in the vertical direction. Here, the case body 55, the accommodation part 60, and the module case 52 are also formed to have a cylindrical shape, and the cover 57 is formed to have a disk shape.

This configuration is an example, and the present disclosure is not limited thereto. As long as the upper or lower end of the receiver dryer 30 is formed to have a shape capable of being accommodated in the accommodation part 60 of the module case 52, the cross-sectional shape of the receiver dryer and the cross-sectional shape of the accommodation part may have a different shape such as a square shape instead of a cylindrical shape. However, the rotatable module case 52 in which the valve body 47 is installed may have a circular cross-sectional shape.

In an embodiment of the present disclosure, the heat exchange part 41 is provided so as to perform heat exchange between the coolant passing through the inside of the heat exchange part and the refrigerant inside the receiver dryer 30. Here, the heat exchange part is installed in a state in which the entirety thereof is inserted into the receiver dryer 30.

In an embodiment of the present disclosure, the heat exchange part 41 may be installed in the internal space of the receiver dryer 30 and may allow the coolant to flow along the inside thereof.

A coolant flow path, which is an internal flow path of the heat exchange pipe 41, communicates with the internal space of the module case 52, thereby enabling the coolant to flow therebetween. To this end, the opposite ends of the heat exchange pipe 41 are inserted into the internal space of the module case 52.

In an embodiment of the present disclosure, the heat exchange pipe 41 has a spiral portion having a spirally wound coil spring shape. In addition, the heat exchange pipe 41 has a straight portion that is bent in the opposite direction from one end of the spiral portion and extends in the shape of a straight line therefrom. The opposite ends of the heat exchange pipe 41 are disposed parallel to each other in a straight line shape.

More specifically, the heat exchange pipe 41 includes a first extension portion 42a formed to extend in the shape of a straight line from one end (e.g., a first end) of the heat exchange pipe, a spiral shape portion 42b formed to extend from an end portion of the first extension portion 42a, the end portion being opposite the one end (e.g., first end), and disposed in a coil shape spirally wound around the first extension portion 42a, and a second extension portion 42c formed to extend again in the shape of a straight line from the spiral shape portion 42b to form the other end of the heat exchange pipe.

In the heat exchange pipe 41 having such a structure, the opposite ends, for example, the one end (e.g., the first end) and the other end (e.g., the second end) are disposed in parallel with a predetermined interval therebetween. Further, the opposite ends of the heat exchange pipe sequentially penetrate the end of the housing 31 of the receiver dryer 30 inserted into the accommodation part 60 of the module case 52 and the cover 57 closely attached thereto, thereby being positioned in the internal space of the module case 52.

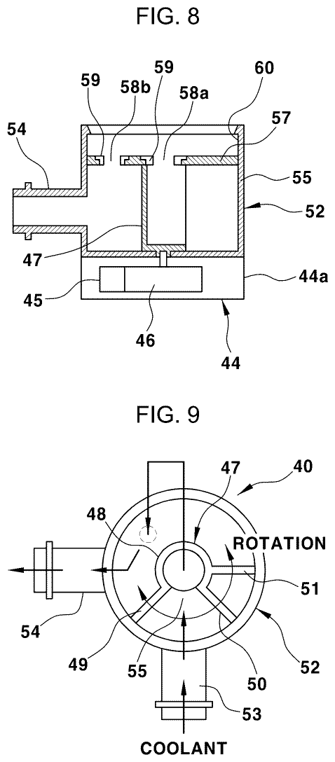

In order to allow one end of the heat exchange pipe 41 to pass through the end of the housing and the cover, through holes (reference numeral “33a” in FIG. 3 and reference numeral “58a” in FIG. 8) are respectively formed on one side (e.g., a first side) of the end of the receiver dryer 30 and one side (e.g., a first side) of the cover 57 closely attached thereto. In this manner, one end (e.g., the first end) of the heat exchange pipe may sequentially pass through the through holes so as to sequentially pass through the end of the housing 31 of the receiver dryer 30 and the cover 57. In this case, the through hole 33a of the receiver dryer 30 and the through hole 58a of the cover 57 are formed at the same position in a state of being aligned with each other, thereby enabling one end of the heat exchange pipe to sequentially pass through the end of the housing 31 and the cover 57.

In addition, in order to allow the other end (e.g., the second end) of the heat exchange pipe 41 to pass through the end of the housing and the cover, through holes (reference numeral “33b” in FIG. 3 and reference numeral “58b” in FIG. 8) are respectively formed on the other side of the end of the receiver dryer 30 and the other side of the cover 57 closely attached thereto. In this manner, the other end of the heat exchange pipe may sequentially pass through the through holes so as to sequentially pass through the end of the housing 31 of the receiver dryer 30 and the cover 57. In this case, the through hole 33b of the receiver dryer 30 and the through hole 5ba of the cover 57 are formed at the same position in a state of being aligned with each other, thereby enabling the other end of the heat exchange pipe to sequentially pass through the end of the housing 31 and the cover 57.

Of the two ends of the heat exchange pipe 41 inserted into the internal space of the module case 52, the one end (e.g., the first end) becomes an inlet through which the coolant is introduced, and the other end (e.g., the second end) becomes an outlet through which the coolant is discharged.

FIG. 6 is a plan view of the module case when viewed in the direction indicated by an arrow “A” in FIG. 3, FIG. 7 is a cross-sectional view taken along line “B-B” in FIG. 3, and FIG. 8 is a cross-sectional view taken along line “C-C” in FIG. 6.

The coolant inlet 53 and the coolant outlet 54 of the heat exchange module 40 are formed on one side (e.g., a first side) and the other side (e.g., a second side) of the module case 52. For example, the coolant inlet 53 and the coolant outlet 54 may be formed so as to be disposed at 90 degrees relative to each other on the cross section of the module case 52.

In addition, the through hole (reference numeral “33a” in FIG. 3) of the receiver dryer 30 and the through hole 58a of the cover 57 through which the inlet of the heat exchange part 41 (heat exchange pipe) sequentially passes may be formed to be respectively located at the central portions of the end of the receiver dryer 30 and the cover 57.

In this case, the through hole (reference numeral “33b” in FIG. 3) of the receiver dryer 30 and the through hole 58b of the cover 57 through which the outlet of the heat exchange part 41 (heat exchange pipe) sequentially passes may be respectively formed to be located away from the central portions of the end of the receiver dryer 30 and the cover 57 by a predetermined distance. The through hole 33b and the through hole 58b may be formed to be located away from the central portions of the end of the receiver dryer 30 and the cover 57 by a distance corresponding to a gap between the two ends of the heat exchange pipe 41.

In an embodiment of the present disclosure, the receiver dryer 30 and the heat exchange pipe 41 (heat exchange part) may each be manufactured using a weldable metal material, and the receiver dryer 30 and the heat exchange pipe 41 may be fixedly coupled to each other by welding.

In a state in which the heat exchange pipe 41 is inserted into the internal space of the receiver dryer 30, the opposite ends of the heat exchange pipe 41 are respectively inserted into the through holes 33a and 33b of the receiver dryer 30 and pass through the same. Here, a portion around each of the through holes of the receiver dryer 30 and an outer circumference of the heat exchange pipe 41 may be fixedly welded to each other so as to achieve a complete sealing state in which no refrigerant leakage occurs in the through holes 33a and 33b.

Then, the opposite ends of the heat exchange pipe 41 fixed to the receiver dryer 30 are respectively inserted into the respective through holes 58a and 58b formed in the cover 57 of the module case 52 so as to pass through the same, thereby connecting the heat exchange pipe 41 to the module case 52.

In this connected state, the inlet of the heat exchange pipe 41 is inserted into the internal space of the module case 52 through the through holes 58a located at the central portion of the plane of the cover 57. Accordingly, the inlet of the heat exchange pipe is also disposed at the central portion of the plane in the internal space of the module case.

Here, the outlet of the heat exchange pipe 41 is inserted into the internal space of the module case 52 through the through hole 58b disposed at a position spaced apart from the central portion of the plane of the cover 57. Accordingly, the outlet of the heat exchange pipe is also disposed at a position spaced apart from the central portion of the plane in the internal space of the module case.

In addition, in an embodiment of the present disclosure, sealing members 59 may be respectively interposed between the through holes 58a and 58b of the cover 57 and the opposite ends of the heat exchange pipe 41 respectively inserted into the through holes so as to pass through the same. Here, each of the sealing members prevents the coolant inside the module case 52 from leaking through each of the through holes 58a and 58b.

FIG. 8 shows the through holes 58a and 58b formed in the cover 57 of the module case 52 and configured to allow the opposite ends of the heat exchange pipe to pass therethrough, and the sealing members 59 respectively installed on the inner side of the through holes 58a and 58b. Each of the sealing members 59 may be made of a material such as rubber.

As described above, welding is performed between each of the through holes 33a and 33b of the receiver dryer 30 and a corresponding one of the outer circumferential surfaces of the opposite ends of the heat exchange pipe 41, thereby achieving reliable sealing performance and securing stable fixation therebetween. However, welding is an example, and the present disclosure is not limited thereto. As described in the cover above, a sealing member may be interposed between each of the through holes of the receiver dryer and a corresponding one of the opposite ends of the heat exchange pipe without welding.

Meanwhile, as described above, in the heat exchange module 40, the actuator case 44a is integrally coupled to the lower end of the case body 55. Further, the cover 57 is inserted into the upper end of the case body 55 and is horizontally coupled thereto so as to seal the internal space of the case body 55 (refer to FIG. 8).

The valve body 47 is rotatably installed in the internal space of the case body 55 sealed by the cover 57. The valve body 47 is rotated by the actuator 46 installed in the actuator case 44a.

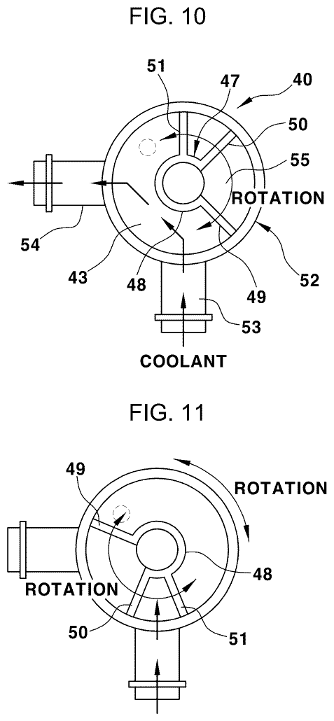

In an embodiment of the present disclosure, the bypass flow path part (reference number “43” in FIGS. 7 and 10) is a flow path space that directly connects the coolant inlet 53 to the coolant outlet 54 in the internal space of the module case 52. In particular, the bypass flow path part is defined as a flow path space through which refrigerant introduced through the coolant inlet 53 of the module case 52 is directly discharged to the coolant outlet 54 without flowing to the heat exchange part 41.

The bypass flow path part 43 is a flow path space formed by blocking walls 48, 49, and 51 of the valve body 47 located in the internal space of the module case 52. In the bypass mode described hereinafter, the bypass flow path part 43 is a flow path space spatially separated from the space around the inlet of the heat exchange pipe (the center space of the module case) among the internal space portions of the module case 52 by the blocking walls 48, 49, and 51 of the valve body 47.

In an embodiment of the present disclosure, the valve device 44 includes the valve body 47 disposed in the module case 52 and configured to allow the coolant inlet 53 of the module case 52 to communicate with or be blocked from one of the bypass flow path part 43 and the heat exchange part 41 depending on the rotation state of the valve body, the actuator 46 configured to rotate the valve body 47, and the valve controller 45 configured to control the operation of the actuator 46.

The actuator 46 may be a motor. The valve controller 45 may be connected to a higher level controller such as a controller of a vehicle thermal management system including the thermal management device of the present disclosure, thereby enabling the valve controller and the higher level controller to communicate with each other.

The controller of the thermal management system transmits a control signal to the valve controller 45 so as to control the operation of the actuator 46. The valve controller 45 controls the operation of the actuator 46 in response to the control signal received from the controller of the thermal management system. Thereby, the rotation position of the valve body 47 may be controlled and the opening state of the valve device 44 may be controlled.

In the present disclosure, the valve device 44 may be controlled to be in a heat exchange mode in which the coolant inlet 53 of the heat exchange module 40 communicates with the coolant flow path of the heat exchange part 41 (heat exchange pipe) and is blocked from the bypass flow path part (reference numeral “43” in FIGS. 7 and 10). Additionally, the valve device 44 may be controlled to be in a bypass mode in which the coolant inlet 53 of the heat exchange module 40 communicates with the coolant outlet 54 through the bypass flow path part 43 and is blocked from the heat exchange part 41. Additionally, the valve device 44 may be controlled to be in a coolant blocking mode in which the coolant inlet 53 of the heat exchange module 40 is blocked from the bypass flow path part 43 and the heat exchange part 41 to prevent the coolant from flowing thereinto.

In the present disclosure, when the operation mode of the heat exchange module 40, for example, one of the heat exchange mode, the bypass mode, and the coolant blocking mode, is selected, the controller of the thermal management system outputs a control signal to rotate the valve body 47 to reach a predetermined rotation position (a “first rotation position”, a “second rotation position”, and a “third rotation position” described hereinafter) of the selected mode. Accordingly, the valve controller 45 that receives the control signal from the controller of the thermal management system controls the operation of the actuator 46 so as to rotate the valve body 47 to reach the rotation position corresponding to the selected mode.

FIG. 7 is a diagram showing the valve body 47 disposed in the internal space of the module case 52. Referring to FIG. 7, the configuration and cross-sectional shape of the valve body 47 may be seen. In addition, FIG. 7 shows the positions at which the inlet and outlet of the heat exchange pipe 41 are inserted into the module case 52 in the cross section of the module case 52.

As shown in FIG. 7, the inlet of the heat exchange pipe 41 is disposed at the central portion of the cross section of the internal space of the module case 52, and the outlet of the heat exchange pipe 41 is disposed at a position spaced apart from the inlet position by a distance corresponding to a gap between the opposite ends of the heat exchange pipe 41.

The valve body 47 may include a central blocking wall 48 located at the central portion of the valve body and formed to have an open shape on one side of the cross section of the central blocking wall, a first blocking wall 49 and a second blocking wall 50 each formed to have a shape extending from a corresponding one of the opposite side ends of the central blocking wall 48 in the radial direction of the cross section of the module case 52, and a third blocking wall 51 disposed at a position spaced apart from the second blocking wall 50 in the circumferential direction and formed to have a shape extending from the central blocking wall 48 in the radial direction of the cross section of the module case 52.

In this configuration, the first blocking wall 49, the second blocking wall 50, and the third blocking wall 51 may be provided such that the respective end portions thereof are in contact with the inner circumferential surface of the module case 52. Accordingly, the internal space of the module case 52 may be partitioned into a plurality of spaces by the central blocking wall 48, the first blocking wall 49, the second blocking wall 50, and the third blocking wall 51.

In addition, in the configuration described above, in the internal space of the module case 52, the inlet of the heat exchange pipe 41 is vertically inserted into the internal space of the central blocking wall 48 in the downward direction from above, and the outlet of the heat exchange pipe 41 is vertically inserted into the space between the third blocking wall 51 and the first blocking wall 49 in the downward direction from above.

FIG. 8 shows the coupling state of the valve body 47 and the actuator 46. As shown in the drawing, the lower portion of the valve body 47 is fixed and coupled to a rotational shaft of the motor which is the actuator 46 so as to be integrally rotatable with the motor. Accordingly, when the motor is driven, the valve body 47 may be rotated in conjunction with the rotational shaft of the motor, and the rotational position of the valve body 47 may be controlled by controlling driving of the motor.

FIGS. 9-11 are diagrams each showing the control state of the valve device and the coolant flow state in an operation mode of the heat exchange module in an embodiment of the present disclosure.

FIG. 9 shows a heat exchange mode in which heat exchange is performed between the refrigerant in the receiver dryer and the coolant discharged from the radiator. In the heat exchange mode, the coolant inlet 53 of the module case 52 communicates with the heat exchange part (heat exchange pipe) so as to enable the coolant to flow therebetween. In this case, the bypass flow path part is blocked.

In this manner, in the heat exchange mode, the operation of the valve device 44 is controlled such that the coolant inlet 53 of the module case 52 communicates with the heat exchange part (heat exchange pipe) so as to enable the coolant to flow therebetween in a state in which the bypass flow path part 43 is blocked.

When the valve body 47 is controlled to be rotated to the first rotation position, which is the rotation position of the heat exchange mode, for example, a rotation position at which the space defined between the central blocking wall 48, the first blocking wall 49, and the second blocking wall 50 communicates with the coolant inlet 53 of the module case 52 so as to enable the coolant to flow therebetween, as shown in FIG. 9, the coolant introduced through the coolant inlet 53 may be introduced into the space between the first blocking wall 49 and the second blocking wall 50.

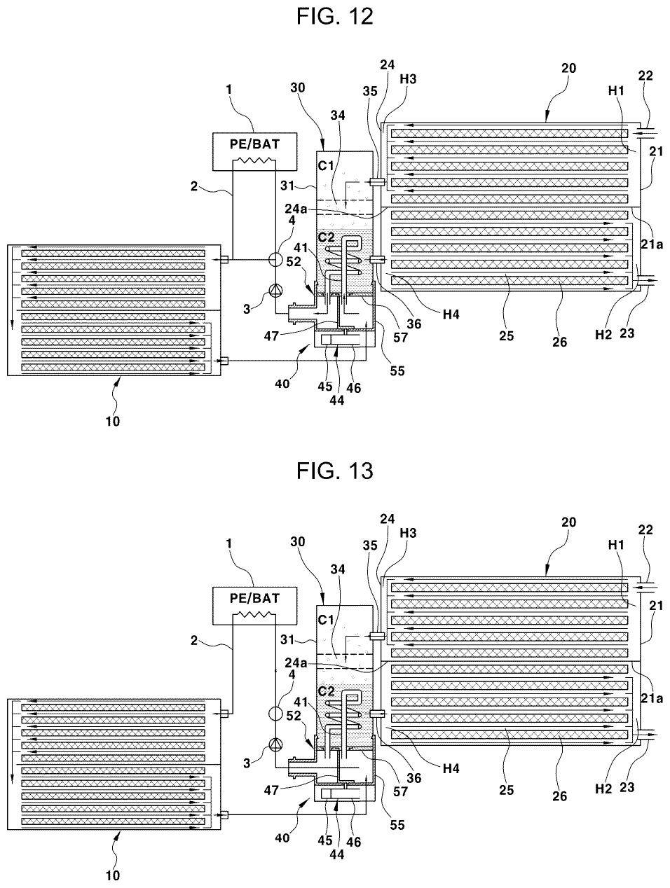

Additionally, the coolant flowing into the space between the first blocking wall 49 and the second blocking wall 50 flows to the internal space of the center blocking wall 48. Thereafter, the coolant may be supplied to and introduced into the inlet of the heat exchange part (heat exchange pipe, reference numeral “41” in FIG. 12) located in the internal space of the center blocking wall 48.

While passing through the heat exchange part 41, the coolant exchanges heat with the refrigerant in the receiver dryer 30 (refer to FIG. 12). At this time, the coolant may be cooled while receiving heat from the refrigerant, and as a result, the pressure of the refrigerant system may be lowered and additional subcooling may be secured.

Thereafter, the coolant passing through the heat exchange part 41 is discharged through the outlet of the heat exchange part 41 into the space between the central blocking wall 48, the third blocking wall 51, and the first blocking wall 49 shown in FIG. 9. Then, the coolant is discharged through the coolant outlet 54 from the internal space of the module case 52.

In this manner, when the valve body 47 is controlled to the first rotation position, the internal space of the central blocking wall 48 and the space between the first blocking wall 49 and the second blocking wall 50 becomes a flow path through which the coolant inlet 53 communicates with the heat exchange part, for example, a flow path configured to allow the coolant introduced into the coolant inlet 53 to flow to the heat exchange part (reference numeral “41” in FIG. 12).

FIG. 10 shows a bypass mode in which the coolant discharged from the radiator bypasses the heat exchange part such that heat exchange between the refrigerant in the receiver dryer and the coolant is not performed.

In the bypass mode, the valve body 47 is controlled to be rotated to the second rotation position, which is the rotation position of the bypass mode, for example, a rotation position at which the bypass flow path part 43, which is the space defined between the central blocking wall 48, the third blocking wall 51, and the first blocking wall 49, communicates with the coolant inlet 53 of the module case 52 so as to enable the coolant to flow therebetween.

In this manner, the operation of the valve device 44 is controlled in the bypass mode such that the coolant inlet 53 of the module case 52 communicates with the bypass flow path part 43 so as to enable the coolant to flow therebetween in a state in which the heat exchange part (heat exchange pipe) is blocked.

At the second rotation position of the valve body 47, the coolant introduced through the coolant inlet 53 may be introduced into the bypass flow path part 43, which is the space defined between the central blocking wall 48, the third blocking wall 51, and the first blocking wall 49, and then may be discharged through the coolant outlet 54 of the module case 52.

In this manner, when the valve body 47 is controlled to be in the second rotation position, the space defined between the central blocking wall 48, the third blocking wall 51, and the first blocking wall 49 may serve as a flow path directly connecting the coolant inlet 53 to the coolant outlet 54, for example, the bypass flow path part 43 is configured to allow the coolant introduced into the coolant inlet 53 to flow to the coolant outlet 54 without flowing into the heat exchange part 41.

In this case, the coolant introduced into the bypass flow path part 43, which is the space defined between the central blocking wall 48, the third blocking wall 51, and the first blocking wall 49, is blocked by the central blocking wall 48, the third blocking wall 51, and the first blocking wall 49 such that the coolant may not flow into the internal space of the central blocking wall 48 and the heat exchange part (reference numeral “41” in FIG. 13).

Accordingly, in the bypass mode, the coolant bypasses the heat exchange part 41 and does not pass through the inside of the receiver dryer 30 such that heat exchange between the coolant and the refrigerant is not performed (refer to FIG. 13).

FIG. 11 shows the coolant blocking mode in which coolant is blocked from passing through the heat exchange module. As shown in FIG. 11, the coolant introduced into the coolant inlet 53 of the module case 52 is blocked by the central blocking wall 48, the second blocking wall 50, and the third blocking wall 51 such that the coolant no longer flows. The heat exchange part (heat exchange pipe) and the bypass flow path part are closed.

In this manner, in the coolant blocking mode, the operation of the valve device 44 is controlled such that the valve body 47 is rotated to a position at which both the heat exchange part and the bypass flow path part are closed, and a coolant flow in the heat exchange module 40 becomes impossible.

In the coolant blocking mode, the valve body 47 is controlled to be rotated to the third rotation position, which is the rotation position of the coolant blocking mode, for example, a rotation position at which the space defined between the central blocking wall 48, the second blocking wall 50, and the third blocking wall 51 communicates with the coolant inlet 53 of the module case 52.

In this case, even if the coolant flows into the space between the central blocking wall 48, the second blocking wall 50, and the third blocking wall 51 through the coolant inlet 53, the coolant is blocked by the central blocking wall 48, the second blocking wall 50, and the third blocking wall 51 and may not flow any more, thereby entering a coolant blocking state.

FIGS. 12-14 are diagrams each showing a flow of coolant and refrigerant in the operation mode of the thermal management device. Arrows in each drawing indicate flow paths of the coolant and the refrigerant.

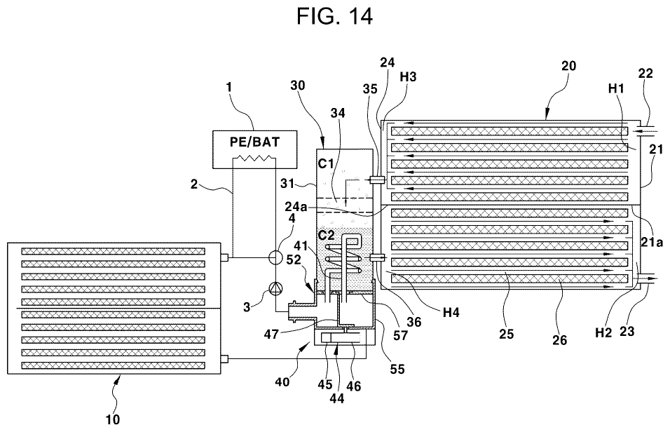

In FIG. 12, the arrows indicate the flow paths of the coolant and the refrigerant in the heat exchange mode. In FIG. 13, the arrows indicate the flow paths of the coolant and the refrigerant in the bypass mode. In FIG. 14, the arrows indicate the flow paths of the refrigerant in the coolant blocking mode.

As shown in FIG. 12, the refrigerant flows through the flow path of the condenser 20, the receiver dryer 30, and then the condenser 20, and the refrigerant introduced through the refrigerant inlet 22 of the condenser 20 exchanges heat with air (outside air) passing through the periphery of the condenser 20 while passing through the internal space of the condenser 20.

In addition, in the heat exchange mode, coolant circulating through the component thermal management system sequentially passes through the radiator 10 and the heat exchange module 40. Here, while the coolant passes through the radiator 10, heat of the coolant is dissipated to the outside (heat dissipation of coolant to the outside) is performed.

In the heat exchange mode, the opening state of the valve device 44 is controlled to allow the coolant inlet 53 of the heat exchange module 40 to communicate with the heat exchange part 41. In this case, the heat exchange part 41 (heat exchange pipe) is opened so as to receive the coolant. At the same time, the bypass flow path part is closed by the valve body 47 of the valve device 44 such that the coolant does not flow through the bypass flow path part.

Accordingly, when the coolant that has completed heat dissipation in the radiator 10 flows into the internal space of the module case 52 through the coolant inlet 53 of the heat exchange module 40, the coolant passes through the heat exchange part 41 that is opened by the valve device 44. Here, while passing through the heat exchange part 41, heat exchange is performed between the coolant and the refrigerant in the receiver dryer 30. At this time, the heat of the refrigerant is transferred to the coolant such that the refrigerant is cooled.

Furthermore, the coolant that has passed through the heat exchange part 41 flows back to the internal space of the module case 52 and is discharged to the outside of the heat exchange module 40 through the coolant outlet 54. Then, the coolant circulates through the component thermal management system again through the coolant line 2.

In the bypass mode shown in FIG. 13, the opening state of the valve device 44 is controlled to allow the coolant inlet 53 of the heat exchange module 40 to communicate with the bypass flow path part. In this case, the bypass flow path part is opened so as to allow the coolant to pass therethrough (refer to FIG. 10). At the same time, the heat exchange part 41 is closed by the valve body 47 of the valve device 44 such that the coolant does not pass through the heat exchange part.

Accordingly, the coolant discharged from the radiator 10 passes through the bypass flow path part (reference symbol “43” in FIG. 10) of the heat exchange module 40. At this time, the coolant bypasses the heat exchange part 41 in which heat exchange between the coolant and the refrigerant in the receiver dryer 30 is performed such that the coolant is discharged directly from the heat exchange module 40 without performing heat exchange with the refrigerant. In addition, the coolant discharged from the heat exchange module 40 is moved to the component thermal management system and is used to cool the devices or parts of the battery or PE system 1.

In the coolant blocking mode shown in FIG. 14, both the heat exchange part 41 and the bypass flow path part of the heat exchange module 40 are closed. Accordingly, the coolant does not flow through the radiator 10 and the heat exchange module 40, and heat exchange between the coolant and the refrigerant in the heat exchange module 40 is not performed.

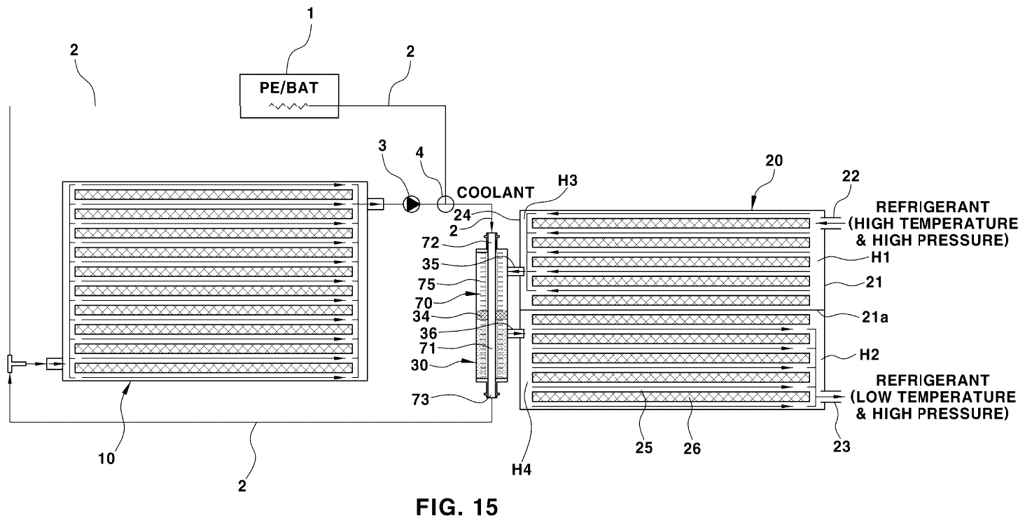

Meanwhile, FIG. 15 is a configuration diagram showing a receiver dryer and a thermal management device including the same according to another embodiment of the present disclosure. Similar to the embodiment of FIG. 1, a receiver dryer 30 capable of performing heat exchange between refrigerant and coolant is described according to an example of the present disclosure.

In the embodiment of FIG. 15, a heat exchange module 70 is installed inside a housing 31 of the receiver dryer 30. While coolant supplied from the radiator 10 passes through the heat exchange module 70 installed inside the housing 31 of the receiver dryer 30, the coolant exchanges heat with refrigerant filling the outside of the heat exchange module 70 in the housing 31 of the receiver dryer 30.

Hereinafter, the embodiment of FIG. 15 is described in detail. In order to perform heat exchange between the refrigerant and the coolant, the receiver dryer 30 of FIG. 15 is provided with the heat exchange module 70 configured to perform heat exchange between the refrigerant and the coolant, similarly to the receiver dryer shown in FIG. 1.

The heat exchange module 70 is configured to allow the coolant to pass therethrough, and the coolant that performs heat exchange with the refrigerant in the heat exchange module 70 is coolant that circulates along the coolant line 2 between the battery or PE system 1 and the radiator 10 by the water pump 3.

In this manner, by using the radiator 10 in which heat exchange between coolant and air is performed and the receiver dryer 30 including the heat exchange module 70, a water-cooled condenser may be implemented in the thermal management device of FIG. 15, similarly to the thermal management device shown in FIG. 1.

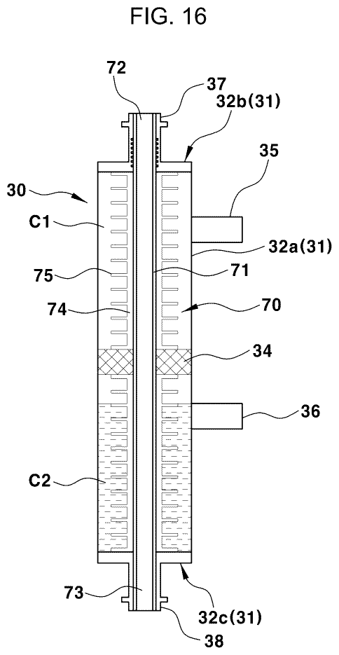

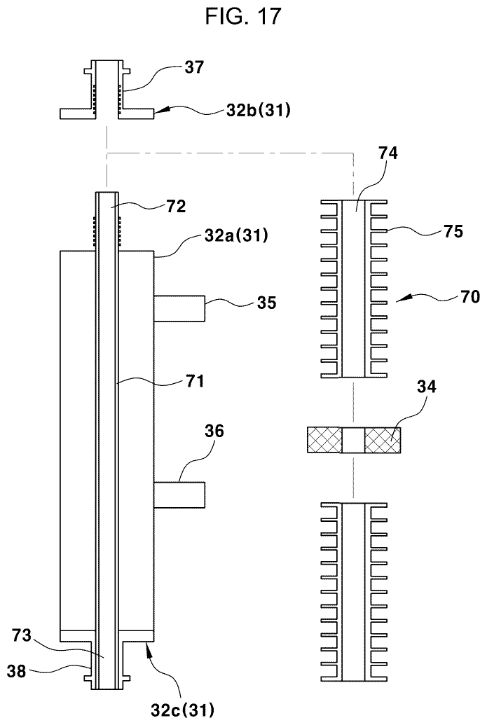

FIG. 16 is a cross-sectional view of the internal configuration of the receiver dryer shown in FIG. 15, and FIG. 17 is an exploded cross-sectional view of components of the receiver dryer shown in FIG. 16.

As shown in FIG. 15, the heat exchange module 70 having a straight and expanded coolant flow path is installed in the receiver dryer 30, and the straight and expanded coolant flow path in the heat exchange module 70 is formed to penetrate the inside of the housing 31 of the receiver dryer 30.

Specifically, in another embodiment of the present disclosure, the heat exchange module 70 includes a heat exchange pipe 71 forming and providing the straight and expanded coolant flow path, and heat dissipation fins 75 installed on the outer surface of the heat exchange pipe 71. In the embodiment of FIG. 15, a portion at which heat exchange is performed, for example, the heat exchange part, becomes the heat exchange pipe 71 and the heat dissipation fins 75.

The heat exchange pipe 71 is a straight pipe having a predetermined diameter and length. The heat exchange pipe may be installed so as to pass through the inside of the housing 31 of the receiver dryer 30 in the vertical direction in the drawing, for example, in the housing axial direction which is the longitudinal direction of the housing.

In addition, the heat exchange pipe 71 may be installed so as to be disposed concentrically with the cylindrical housing 31 having a predetermined diameter and length. In this case, the heat exchange pipe 71 may be installed so as to be disposed along the central axis line inside the housing 31.

The housing 31 has a first port part 37 provided at one end thereof (upper end in the drawing) and formed to protrude upwards, in which one end (upper end in the drawing) of the heat exchange pipe 71 is coupled to the first port part in a state of being accommodated therein and inserted thereinto. Further, the housing 31 has a second port part 37 provided at the other end thereof (lower end in the drawing) and formed to protrude downwards, in which the other end (lower end in the drawing) of the heat exchange pipe 71 is coupled to the second port part in a state of being accommodated therein and inserted thereinto.

The coolant line 2 is connected to the first port part 37 and the second port part 38 of the housing 31. Here, one end (upper end in the drawing) of the heat exchange pipe 71 inserted into the inside of the first port part 37 and an internal passage of the one end become a coolant inlet/outlet 72 (hereinafter referred to as a “first coolant inlet/outlet”) through which coolant enters and exits the receiver dryer 30 and the heat exchange module 70.

In the same manner, the other end (lower end in the drawing) of the heat exchange pipe 71 inserted into the inside of the second port part 38 and an internal passage of the other end become another coolant inlet/outlet 73 (hereinafter referred to as a “second coolant inlet/outlet’) through which coolant enters and exits the receiver dryer 30 and the heat exchange module 70.

In the present disclosure, the heat exchange pipe 71 may be made of a metal material having excellent thermal conductivity. For example, a metal material containing copper or aluminum may be used.

In addition, a plurality of heat dissipation fins 75 is installed on the outer circumferential surface of the heat exchange pipe 71 in a state of being spaced apart from each other with a predetermined interval therebetween in the longitudinal direction of the heat exchange pipe 71. In an embodiment, the heat dissipation fins 75 may be installed so as to be spaced apart from each other at equal intervals therebetween in the longitudinal direction of the heat exchange pipe 71.

In the present disclosure, each of the heat dissipation fins 75 may be manufactured using a metal material having excellent thermal conductivity, such as a metal containing copper or aluminum. Additionally, each of the heat dissipation fins 75 may be provided in a disk shape having a predetermined thickness. Regarding the diameter of the heat dissipation fin, the heat dissipation fin is provided so as to form an appropriate gap between the peripheral portion (the entire circumference of the edge) of the heat dissipation fin 75 and the inner circumferential surface of the housing 31 of the receiver dryer 30 in a state of being installed on the heat exchange pipe 71.

In an embodiment of the present disclosure, although the heat dissipation fins 75 may be individually directly fixed to the outer circumferential surface of the heat exchange pipe 71 by welding or the like, it is also possible to apply a structure in which the heat dissipation fins 75 are fixed to the outer surface (outer circumferential surface) of the heat exchange pipe 71 with a separate pipe member 74 interposed therebetween.

The heat dissipation fins 75 each having a disk shape are horizontally installed on the outer circumferential surface of the pipe member 74 such that the heat dissipation fins are arranged and fixed with a predetermined interval therebetween in the longitudinal direction of the pipe member 74, and the heat exchange pipe 71 is inserted into the inside of the pipe member 74, thereby coupling the heat exchange pipe 71 to the pipe member 74.

In this case, the inner circumferential surface of the pipe member 74 and the outer circumferential surface of the heat exchange pipe 71 are in close contact with each other. In this manner, a plurality of heat dissipation fins 75 may be fixed at the respective predetermined positions on the outer circumferential surface of the heat exchange pipe 71 with the pipe member 74 interposed therebetween, thereby enabling the heat dissipation fins to be integrated with the heat exchange pipe.

In an embodiment of the present disclosure, similarly to the heat dissipation fins 75, the pipe member 74 may also be manufactured using a metal material having excellent thermal conductivity, such as a metal containing copper or aluminum. Furthermore, when fixing the heat dissipation fins 75 to the outer surface (outer circumferential surface) of the pipe member 74, a method such as welding may be used.

The filter 34 is installed horizontally on the outer circumferential surface of the heat exchange pipe 71. The filter 34 is installed to partition the internal space of the housing 31 into an upper portion and a lower portion as shown in the drawing in a state in which the heat exchange module 70 including the heat exchange pipe 71 and the heat dissipation fins 75 is housed in the housing 31 of the receiver dryer 30.

The inside of the housing 31 of the receiver dryer 30 is partitioned into an upper chamber C1 and a lower chamber C2 by the filter 34. Here, in the condenser 20, the upper chamber H3 of the second header tank 24 is connected to the upper chamber C1 of the receiver dryer 30 through the connection passage 35 so as to enable the refrigerant to flow therebetween, and the lower chamber H4 of the second header tank 24 is connected to the lower chamber C2 of the receiver dryer 30 through another connection passage 36 so as to enable the refrigerant to flow therebetween.

Since the receiver dryer 30 receives the refrigerant from the upper chamber H3 of the second header tank 24 of the condenser 20 through the connection passage 35 connected to the upper chamber C1, an inlet portion of the upper chamber C1 of the receiver dryer 30, the inlet portion being connected to the connection passage 35, becomes a refrigerant inlet through which the refrigerant is introduced.

In addition, since the receiver dryer 30 discharges the refrigerant through the connection passage 36 connected to the lower chamber C2 and moves the refrigerant to the lower chamber H4 of the second header tank 24 of the condenser 20, an outlet portion of the lower chamber C2 of the receiver dryer 30, the outlet portion being connected to the connection passage 36, becomes a refrigerant outlet through which the refrigerant is discharged.

Referring to FIG. 16, a first one of the coolant inlet or outlet 72 is provided at the upper end of the receiver dryer 30, and a second one of the coolant inlet or outlet 73 is provided at the lower end of the receiver dryer 30. In addition, the heat exchange pipe 71 that forms and provides a coolant flow path is disposed to penetrate the inside of the housing 31 of the receiver dryer 30 in the vertical axial direction.

Furthermore, as described above, a plurality of heat dissipation fins 75 may be installed on the outer circumferential surface of the heat exchange pipe 71 with the pipe member 74 interposed therebetween. A plurality of heat dissipation fins 75 may be installed with a predetermined interval therebetween, for example, a constant interval therebetween in the axial direction of the heat exchange pipe 71.

In addition, referring to FIG. 16, the filter 34 is disposed in the internal space of the housing 31 of the receiver dryer 30 at the approximately middle position in the longitudinal direction of the heat exchange pipe 71, for example, at the middle height of the heat exchange pipe 71 in the drawing. The filter 34 is disposed horizontally to partition the internal space of the housing 31 of the receiver dryer 30 into the upper chamber C1 and the lower chamber C2.

In the internal space of the housing 31 of the receiver dryer 30, refrigerant supplied from the condenser 20 through the connection passage is introduced into the upper chamber C1, and refrigerant is discharged through the lower chamber C2 through the connection passage connected to the condenser 20.

In the internal space of housing 31 of the receiver dryer 30, heat exchange between the refrigerant and the coolant is performed by the heat exchange module 70. Gaseous and liquid refrigerants exist in the upper chamber C1 of the internal space of the receiver dryer 30.

Therefore, heat exchange between the gaseous and liquid refrigerants and the coolant is performed while the coolant passes through the heat exchange pipe 71 of the heat exchange module 70 in the upper chamber C1 of the receiver dryer 30.

Further, liquid refrigerant is present in the lower chamber C2 of the receiver dryer 30. Therefore, heat exchange between the liquid refrigerant and the coolant is performed while the coolant passes through the heat exchange pipe 71 of the heat exchange module 70 in the lower chamber C2 of the receiver dryer 30.

In this embodiment, the housing 31 of the receiver dryer 30 includes a housing body 32a having the heat exchange module 70 installed in the internal space thereof, in which the internal space is partitioned into the upper chamber C1 and the lower chamber C2 by the filter 34, and caps 32b and 32c configured to seal the internal space of the housing body 32a. The caps 32b and 32c are respectively installed at one end (the upper end in the drawing) of the housing body 32a and the other end (the lower end in the drawing) thereof.

In an embodiment of the present disclosure, the housing body 32a of the housing 31 is disposed to extend in the vertical direction. Here, the heat exchange pipe 71 is disposed to penetrate the housing body 32a vertically, thereby enabling the coolant to vertically pass through the receiver dryer 30 and the heat exchange module 70.

In this configuration, the respective ends of the heat exchange pipe 71 are inserted into the inner sides of the caps 32b and 32c and are fixedly coupled thereto. Here, the lower cap 32c may be integrally fixed to the lower end of the housing body 32a by welding or the like. The second port part 38 is formed in the lower cap 32c.

In addition, the lower end of the heat exchange pipe 71 inserted into the housing body 32a is fixed in a state of being inserted into the lower cap 32c of the receiver dryer 30 by using a method in which the heat exchange pipe 71 is pressed into the lower cap 32c such that the outer circumferential surface of the lower end of the heat exchange pipe 71 is in close contact with the inner surface of the lower cap 32c or a method in which the heat exchange pipe 71 and the lower cap 32c are welded in a state of being in close contact with each other. Alternatively, the outer circumferential surface of the lower end of the heat exchange pipe 71 may be screwed to the inner circumferential surface of the lower cap 32c.

In addition, after sequentially assembling the lower pipe member 74 having the heat dissipation fins 75 fixedly installed thereon, the filter 34, and the upper pipe member 74 having the heat dissipation fins 75 fixedly installed thereon on the outer circumference of the heat exchange pipe 71 inserted into the housing body 32a, the upper cap 32b is coupled to the upper end of the heat exchange pipe 71, and the upper cap 32b is fixed to the upper end of the housing body 32a. The first port part 37 is formed in the upper cap 32b.

In this case, the upper end of the heat exchange pipe 71 is fixed in a state of being inserted into the inside of the upper cap 32b, and the outer circumferential surface of the upper end of the heat exchange pipe 71 and the inner circumferential surface of the upper cap 32b may be screwed to each other by screw threads of both sides. The upper cap 32b screwed thereto in this manner may be integrally fixed to the upper end of the housing body 32a by welding or the like.

In this manner, it is possible to form the heat exchange module 70 including the straight heat exchange pipe 71 penetrating the inside of the receiver dryer 30 in the vertical direction and a plurality of heat dissipation fins 75 installed on the outer circumferential surface of the heat exchange pipe 71.

In the receiver dryer 30 including the heat exchange module 70 having such a configuration, coolant performing heat exchange with refrigerant passes through the straight and expanded coolant flow path provided in the receiver dryer 30, thereby reducing coolant flow resistance.

In addition, the heat dissipation fins 75 are components that increase a contact area between the coolant and the refrigerant, thereby increasing the amount of heat exchange in the heat exchange module 70. As a result, in the receiver dryer 30 including the heat exchange module 70 having the above configuration, heat dissipation performance may be maximally improved, and additional subcooling may be secured.

In addition, water-cooled condensation may be implemented through the radiator 10 without an additional heat exchanger such as a conventional plate heat exchanger. Further, compared to the embodiment of FIG. 1, since the heat exchange module 70 has a simple configuration in which the heat dissipation fins 75 are installed on the straight heat exchange pipe 71, a manufacturing process may be simplified, and reduction of cost may be achieved.

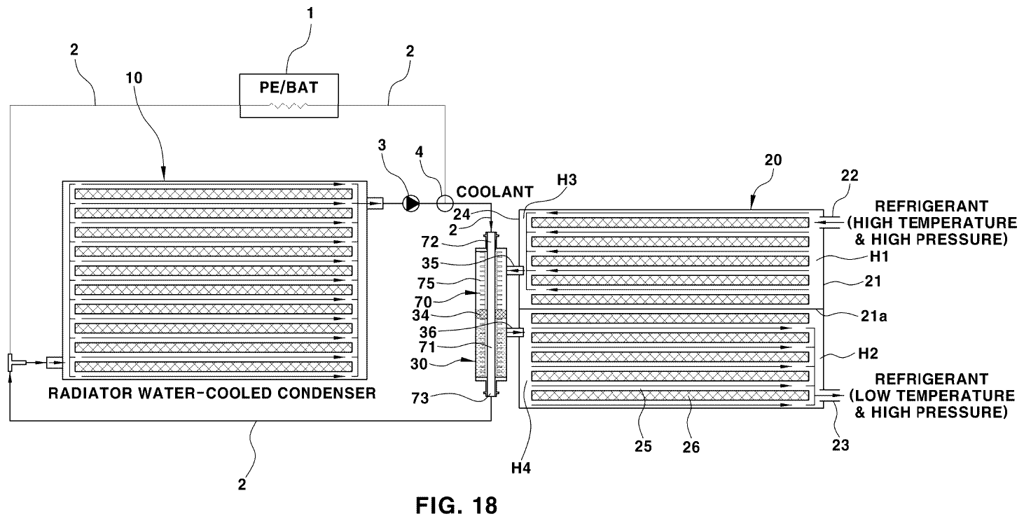

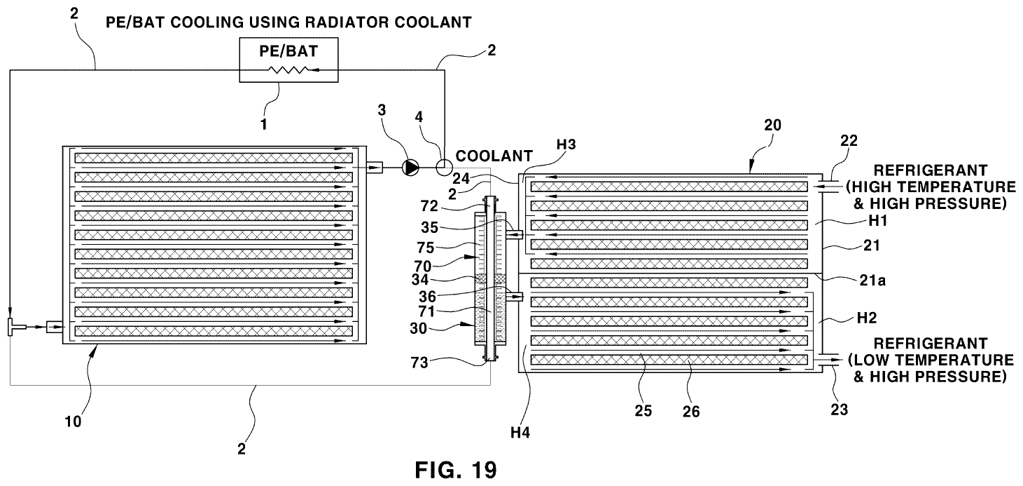

FIGS. 18 and 19 are drawings showing a flow of coolant and refrigerant in the operation mode of the thermal management device shown in FIG. 15, and arrows in each drawing indicate a flow path of the coolant and the refrigerant.

FIG. 18 is a drawing showing a heat exchange mode in which heat exchange between the refrigerant and the coolant is performed through the heat exchange module 70. Here, in the bypass mode, for thermal management of the battery or PE system 1, the coolant circulates along the coolant line 2 between the battery or PE system 1 and the radiator 10, but the coolant is not supplied to the heat exchange module 70.

More specifically, in the heat exchange mode, as shown in FIG. 18, the refrigerant flows through the flow path of the condenser 20, the receiver dryer 30, and then the condenser 20 again. Further, the high-temperature and high-pressure refrigerant introduced through the refrigerant inlet 22 of the condenser 20 exchanges heat with air (outside air) passing through the periphery of the condenser 20 while passing through the internal space of the condenser 20.

In addition, in the heat exchange mode, the coolant sent by the water pump 3 sequentially passes through the radiator 10 and the heat exchange module 70. Here, while the coolant passes through the radiator 10, heat dissipation to the outside air is performed so as to dissipate the heat of the coolant to the outside air.

In the heat exchange mode, the opening state of the flow control valve 4 may be controlled such that the coolant line 2 on the outlet side of the water pump 3 communicates with the coolant line 2 connected to the first one of the coolant inlet or outlet 72 of the heat exchange module 70 in a state of being blocked from the coolant line 2 connected to the battery or PE system 1.

Accordingly, the heat exchange pipe 71 of the heat exchange module 70 may receive the coolant that has passed through the radiator 10. The coolant that has completed heat dissipation in the radiator 10 may move along the coolant line 2 and may flow into the heat exchange module 70 through the first one of the coolant inlet or outlet 72, which is the upper one of the coolant inlet or outlet of the heat exchange pipe 71.

Then, the coolant exchanges heat with the refrigerant in the receiver dryer 30 while passing through the heat exchange pipe 71 of the heat exchange module 70 having the heat dissipation fins 75 installed thereon. At this time, the heat from the refrigerant is transferred to the coolant such that the refrigerant may be cooled.

In addition, the coolant passing through the heat exchange pipe 71 is discharged to the outside of the heat exchange module 70 through the second one of the coolant inlet or outlet 73, which is the lower one of the inlet or outlet. Thereafter, the coolant flows along the coolant line 2 and passes through the radiator 10 again.

In the condenser 20, high-temperature and high-pressure refrigerant is introduced into the upper chamber H1 of the first header tank 21 through the refrigerant inlet 22. Then, while passing through the tube 25 of the condenser 20, the refrigerant exchanges heat with the air (outside air) passing through the periphery of the fin 26.

The refrigerant that has completed the heat exchange in the condenser 20 flows from the upper chamber H3 of the second header tank 24 to the upper chamber C1 of the receiver dryer 30 through the upper connection passage 35, and the gaseous and liquid refrigerants supplied to the upper chamber C1 of the receiver dryer 30 exchange heat with the coolant passing through the heat exchange pipe 71 of the heat exchange module 70.

Furthermore, the liquid refrigerant collected in the lower chamber C2 of the receiver dryer 30 flows to the lower chamber H4 of the second header tank 24 of the condenser 20 through the lower connection passage 36, and then exchanges heat with the air (outside air) passing through the periphery of the fin 26 while passing through the tube 25 of the condenser 20.

In this manner, the low-temperature and high-pressure refrigerant that has completed the heat exchange while passing through the tube 25 is discharged to the refrigerant line through the refrigerant outlet 23 in the lower chamber H2 of the first header tank 21 of the condenser 20.

Next, FIG. 19 is a drawing showing the bypass mode in which the coolant bypasses the heat exchange module 70 without passing through the same. In the drawing, arrows indicate the flow paths of the coolant and refrigerant in the bypass mode.

In the bypass mode of FIG. 19, the coolant is not supplied to the heat exchange module 70 while circulating along the coolant line 2 between the battery or PE system 1 and the radiator 10, and the coolant that has passed through the battery or PE system 1 dissipates heat to the outside air while passing through the radiator 10.

In this bypass mode, the opening state of the flow control valve 4 is controlled such that the coolant line 2 on the outlet side of the water pump 3 communicates with the coolant line 2 connected to the battery or PE system 1 in a state of being blocked from the coolant line 2 connected to the first one of the coolant inlet or outlet 72 of the heat exchange module 70.

Accordingly, the coolant discharged from the radiator 10 may be used to cool the battery or PE system by moving directly from the flow control valve 4 to the battery or PE system 1 without performing heat exchange with the refrigerant.

Although not shown in the drawing, the coolant blocking mode in which coolant does not flow through the radiator 10 and the heat exchange module 70 may be performed. In the coolant blocking mode, the water pump 3 and the flow control valve 4 are controlled such that the coolant does not pass through the radiator 10 and the heat exchange module 70. In this manner, heat exchange between the coolant and other media is not performed in the radiator 10 and the heat exchange module 70.

In the embodiment of FIG. 15, a direction in which the coolant passes through the heat exchange pipe 71 may be the same direction as or opposite to a direction in which the refrigerant passes through the receiver dryer 30.

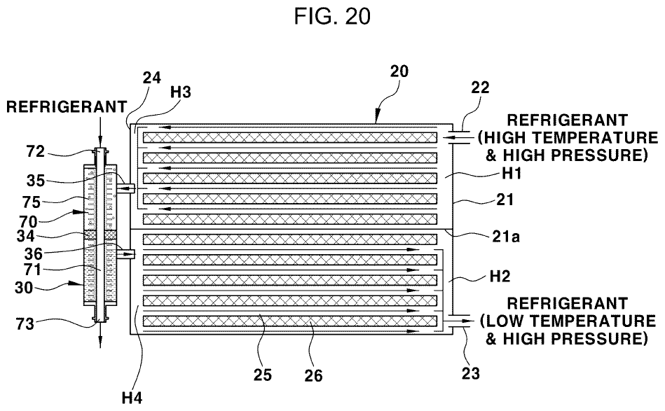

FIG. 20 is a drawing showing an embodiment in which coolant is introduced through the first one of coolant inlet or outlet 72 and then is discharged through the second one of the coolant inlet outlet 73. In this embodiment, as shown in FIG. 15, the coolant line 2 extending from the flow control valve 4 is connected to the first coolant inlet outlet 72, and the coolant line 2 connected to the second coolant inlet/outlet 73 is connected to the coolant inlet side of the radiator 10.

In the embodiment of FIG. 20, the coolant flowing along the coolant line 2 from the flow control valve 4 is introduced through the first coolant inlet or outlet 72 of the heat exchange module 70, passes through the heat exchange pipe 71 in the downward direction, and then is discharged through the second coolant inlet or outlet 73 to the coolant line 2.

In this case, the refrigerant is discharged from the condenser 20 and is supplied to the upper chamber C1 of the receiver dryer 30 through the upper connection passage 35. Thereafter, after flowing to the lower chamber C2 of the receiver dryer 30, the refrigerant is discharged through the lower connection passage 36 and flows to the condenser 20. At this time, the refrigerant passes through the receiver dryer 30 in the downward direction, and as a result, the direction of passage of the refrigerant and the direction of passage of the coolant become the same direction.

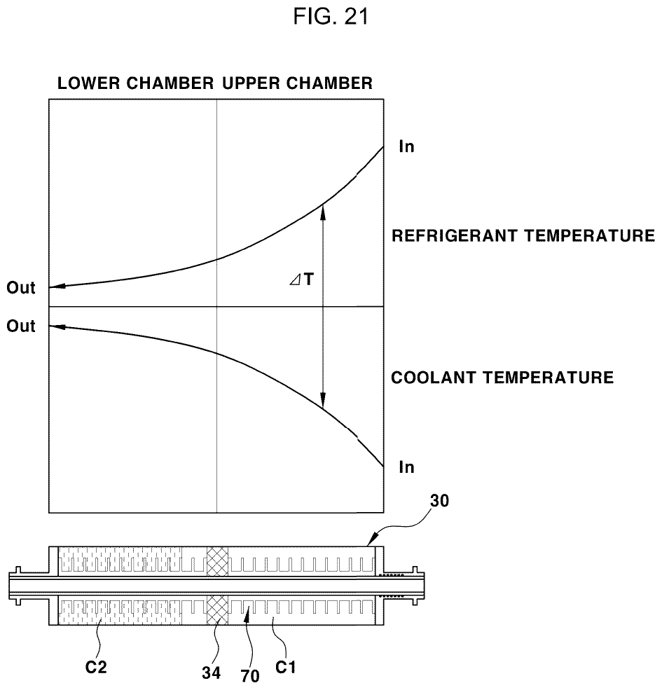

FIG. 21 is a drawing showing the temperature of refrigerant and coolant while the refrigerant and the coolant pass through the receiver dryer 30 in the heat exchange device configured to allow the refrigerant and the coolant to flow in the same direction.

The refrigerant, which is a medium that provides heat in the receiver dryer 30, has the highest temperature at the inlet side located in the upper chamber C1 (a portion at which heat exchange between coolant and gaseous and liquid refrigerants is performed) of the receiver dryer 30, whereas the temperature of refrigerant gradually decreases in the downward direction away from the upper chamber. As a result, the refrigerant has the lowest temperature at the outlet side located in the lower chamber C2 (a portion at which heat exchange between coolant and liquid refrigerant is performed).

On the other hand, the temperature of the coolant shows the opposite tendency to the temperature of the refrigerant. The coolant, which is a medium receiving heat from the receiver dryer 30, has the lowest temperature at the inlet (the first coolant inlet/outlet) located in the upper chamber C1 (a portion at which heat exchange between coolant and gaseous and liquid refrigerants is performed) of the receiver dryer 30, whereas the temperature of the coolant gradually increases in the downward direction away from the upper chamber. As a result, the coolant has the highest temperature at the outlet side (the second coolant inlet/outlet) located in the lower chamber C2 (a portion at which heat exchange between coolant and liquid refrigerant is performed).

In this manner, the coolant cooled in the radiator 10 sequentially exchanges heat with the refrigerant while passing through the heat exchange module 70 provided in the receiver dryer 30 in the downward direction, thereby securing additional subcooling following additional heat dissipation in the radiator 10.

In this embodiment, since the coolant flow path of the heat exchange module 70 in the receiver dryer 30 is provided in a straight line, flow resistance of the coolant passing through the straight flow path is reduced compared to the embodiment of FIG. 1.

In addition, although it is difficult to install heat dissipation fins on the curved heat exchange pipe 41 of FIG. 1, in the embodiments of FIG. 15 and FIG. 20, the straight heat exchange pipe 71 is used to enable the heat dissipation fins 75 to be installed thereon. As a result, in the embodiments of FIG. 15 and FIG. 20, the heat exchange amount may be increased through the heat dissipation fins 75, thereby significantly improving system efficiency.

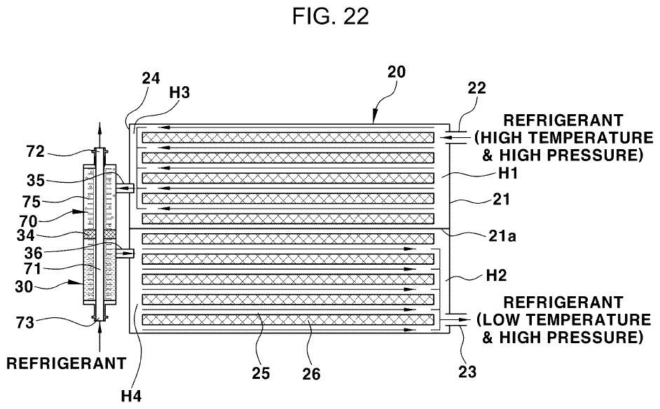

FIG. 22 is a drawing showing an embodiment in which coolant is introduced through the second coolant inlet/outlet 73 and then is discharged through the first coolant inlet/outlet 72. In this embodiment, the coolant line 2 extending from the flow control valve 4 is connected to the second coolant inlet or outlet 73, and the coolant line 2 connected to the first coolant inlet or outlet 72 is connected to the coolant inlet side of the radiator 10.

In the embodiment of FIG. 22, the coolant flowing along the coolant line 2 from the flow control valve 4 is introduced through the second coolant inlet or outlet 73 of the heat exchange module 70, passes through the heat exchange pipe 71 in the upward direction, and then is discharged into the coolant line 2 through the first coolant inlet/outlet 72. In this case, since the refrigerant passes through the receiver dryer 30 in the downward direction, a direction in which the refrigerant flows is opposite a direction in which the coolant flows (reverse direction).

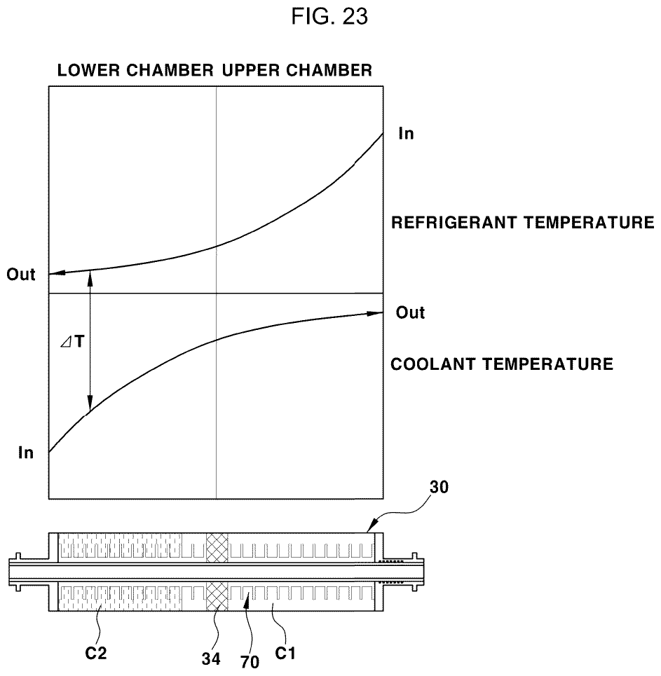

FIG. 23 is a drawing showing the temperature of refrigerant and coolant while the refrigerant and the coolant pass through the receiver dryer 30 in the heat exchange device configured to allow the refrigerant and the coolant to flow in opposite directions.

The refrigerant, which is a medium providing heat in the receiver dryer 30, has the highest temperature at the inlet side located in the upper chamber C1 (a portion at which heat exchange between coolant and gaseous and liquid refrigerants is performed) of the receiver dryer 30. As the refrigerant moves in the downward direction away from the upper chamber (i.e., flowing downward from the upper chamber), the temperature of the refrigerant gradually decreases. As a result, the refrigerant has the lowest temperature at the outlet side located in the lower chamber C2 (a portion at which heat exchange between coolant and liquid refrigerant is performed).

On the other hand, the temperature of the coolant shows a similar tendency to the temperature of the refrigerant. The coolant, which is a medium receiving heat from the receiver dryer 30, has the lowest temperature at the inlet (the second coolant inlet/outlet) located in the lower chamber C2 (a portion at which heat exchange between coolant and liquid refrigerants is performed) of the receiver dryer 30, whereas the temperature of the coolant gradually increases as it flows in the upward direction away from the lower chamber. As a result, the coolant has the highest temperature at the outlet side (the first coolant inlet/outlet) located in the upper chamber C1 (a portion at which heat exchange between coolant and gaseous and liquid refrigerants is performed).

As shown in the embodiment of FIG. 22, the coolant cooled in the radiator 10 sequentially exchanges heat with the refrigerant while passing through the heat exchange module 70 provided in the receiver dryer 30 in the upward direction, thereby securing additional subcooling following additional heat dissipation in the radiator 10.

In addition, in the embodiment of FIG. 22, since the coolant flow path of the heat exchange module 70 in the receiver dryer 30 is provided in a straight line, flow resistance of the coolant passing through the straight flow path is reduced compared to the embodiment of FIG. 1.

Further, in the embodiment of FIG. 22, since the straight heat exchange pipe 71 is used to enable the heat dissipation fins 75 to be installed thereon. As a result, the heat exchange amount may be increased through the heat dissipation fins 75, thereby significantly improving system efficiency.

As is apparent from the above description, the present disclosure provides a receiver dryer and a vehicle thermal management device including the same. The vehicle thermal management device provides a new type of water-cooled condensing technique utilizing the receiver dryer and a radiator, thereby making it possible not only to secure an additional subcooling area, but also to increase heat dissipation amount. In this manner, the vehicle thermal management device has an effect of solving a heat load problem in electric vehicles and improving marketability of electric vehicles.

Furthermore, according to the present disclosure, when rapid charging of a battery and vehicle interior cooling are simultaneously performed, the heat of refrigerant may be additionally dissipated to the outside through a heat exchange module installed in the receiver dryer, thereby having an effect of stabilizing a high-temperature and high-pressure state in a refrigerant system and achieving improvement in interior cooling performance, battery cooling performance, and the like.

Additionally, it is possible to secure an additional subcooling area by simply installing the heat exchange module having a simple configuration in the receiver dryer without installation of a separate water-cooled heat exchanger that performs heat exchange between refrigerant and coolant, thereby having an effect of reducing the number of components and simplifying a system configuration as compared with a conventional configuration including the water-cooled heat exchanger.

As described above, the embodiments of the present disclosure have been described in detail. In addition, since the embodiments described in this specification and the configurations shown in the drawings are only illustrative embodiments of the present disclosure, the scope of the present disclosure is not limited to the above-described embodiments. Various modifications and improvements made by those having ordinary skill in the art using the basic concept of the present disclosure defined in the following claims also fall within the scope of the present disclosure.

What is claimed is:

1. A receiver dryer configured to remove moisture from refrigerant discharged through a condenser and supplied to an inside of a housing and to separate the refrigerant into liquid refrigerant and gaseous refrigerant at the inside of the housing, the receiver dryer comprising:
a heat exchange module connected to a radiator through a coolant line so as to enable coolant passing through the radiator to be supplied to the heat exchange module, the heat exchange module being configured to selectively perform heat exchange between the coolant supplied from the radiator and the refrigerant inside of the housing.

2. The receiver dryer of claim 1, wherein the heat exchange module is coupled to an upper end of the housing or a lower end of the housing.

3. The receiver dryer of claim 1, wherein the heat exchange module comprises a heat exchange part configured to allow the coolant to pass through an inside thereof, the heat exchange part configured to perform the heat exchange between the coolant flowing through the inside of the heat exchange part and the refrigerant inside of the housing.

4. The receiver dryer of claim 3, wherein the heat exchange part is a heat exchange pipe having a spirally wound coil spring shape.

5. The receiver dryer of claim 1, wherein the heat exchange module comprises:
a heat exchange part configured to perform the heat exchange between the coolant flowing through an inside of the heat exchange part and the refrigerant inside of the housing;
a bypass flow path part configured to allow the coolant to bypass the heat exchange part without passing through the heat exchange part; and
a valve device configured to control a flow of the coolant so as to allow the coolant supplied from the radiator to selectively flow through the heat exchange part or the bypass flow path part.

6. The receiver dryer of claim 5, wherein the heat exchange module further comprises a module case configured to allow the coolant to pass therethrough, wherein the module case comprises:
a coolant inlet configured to allow the coolant passing through the radiator to be introduced thereinto; and
a coolant outlet configured to allow the coolant passing through an internal space of the module case to be discharged therethrough.

7. The receiver dryer of claim 6, wherein the module case further comprises an accommodation part configured to allow an end of the housing to be inserted and coupled thereto.

8. The receiver dryer of claim 6, wherein the valve device comprises:
a valve body rotatably disposed in the internal space of the module case, wherein the valve body is configured to cause the coolant inlet to selectively communicate with, depending on a rotation position of the valve body, the heat exchange part or the bypass flow path part such that the coolant flows through a selected one of the heat exchange part or the bypass flow path part;
an actuator configured to rotate the valve body; and
a valve controller configured to control an operation of the actuator.

9. The receiver dryer of claim 8, wherein the valve body comprises a plurality of blocking walls including:
a central blocking wall located at a central portion of the valve body, wherein the central blocking wall has an open shape on one side of a cross section thereof;
a first blocking wall and a second blocking wall, each disposed and extending from the central blocking wall in a radial direction; and
a third blocking wall disposed at a position spaced apart from the second blocking wall, the third blocking wall extending from the central blocking wall in the radial direction.

10. The receiver dryer of claim 9, wherein:
the heat exchange part is disposed at the inside of the housing,
the heat exchange part includes first and second ends penetrating the housing and the module case, wherein the first and second ends are inserted into the internal space of the module case,
the first end of the heat exchange part is an inlet configured to allow the coolant to flow into the heat exchange part, the first end being disposed at an inner side of the central blocking wall in the module case, and
the second end of the heat exchange part is an outlet configured to allow the coolant passing through the heat exchange part to be discharged therethrough, the second end being disposed in a space defined between the first blocking wall and the third blocking wall.

11. The receiver dryer of claim 9, wherein the plurality of blocking walls is configured to partition the internal space of the module case and configured to:
cause the coolant inlet to communicate with the heat exchange part at a first rotation position,
cause the coolant inlet to communicate with the bypass flow path part at a second rotation position, and
simultaneously block the coolant inlet from communicating with the heat exchange part and the bypass flow path part at a third rotation position.

12. The receiver dryer of claim 11, wherein when the valve body is controlled to be in the second rotation position,
a space in the internal space of the module case, defined between the central blocking wall, the third blocking wall, and the first blocking wall, is configured to serve as the bypass flow path part configured to enable the coolant inlet and the coolant outlet to communicate with each other.

13. The receiver dryer of claim 11, wherein when the valve body is controlled to be in the first rotation position,
a space in the internal space of the module case, defined between the central blocking wall, the first blocking wall, and the second blocking wall, is configured to serve as a flow path space configured to enable the coolant inlet and the inlet of the heat exchange part to communicate with each other.

14. The receiver dryer of claim 11, wherein when the valve body is controlled to be in the third rotation position,
the central blocking wall, the second blocking wall, and the third blocking wall are configured to simultaneously block the coolant inlet from the heat exchange part and the bypass flow path part.

15. The receiver dryer of claim 1, wherein:
the heat exchange module is installed at the inside of the housing, and
the coolant supplied from the radiator is configured to exchange heat with the refrigerant filling the inside of the housing and an outside of the heat exchange module, while passing through the heat exchange module inside the housing.

16. The receiver dryer of claim 15, wherein the heat exchange module comprises:
a heat exchange pipe forming a straight coolant flow path; and
heat dissipation fins installed on an outer side of the heat exchange pipe.

17. The receiver dryer of claim 16, wherein:
the heat exchange pipe is a straight pipe disposed at the inside of the housing and installed in a longitudinal direction of the housing, and
the heat exchange pipe has opposite ends respectively located at opposite ends of the housing, and a coolant inlet and a coolant outlet are respectively disposed in the opposite ends of the heat exchange pipe, wherein each of the coolant inlet and the outlet is connected to the coolant line and is configured to allow the coolant to be introduced thereinto or discharged therethrough.

18. The receiver dryer of claim 17, wherein:
the housing comprises a housing body and caps respectively installed at opposite ends of the housing body,
the heat exchange pipe is installed to vertically pass through an inside of the housing body, and
the coolant inlet and the coolant outlet are respectively located at the opposite ends of the heat exchange pipe, and the opposite ends of the heat exchange pipe are respectively inserted into and coupled to the caps, thereby allowing the coolant to vertically pass through the inside of the housing along the heat exchange pipe.

19. The receiver dryer of claim 16, wherein:
the housing includes a plurality of the heat dissipation fins provided at the inside of the housing, the heat dissipation fins being disposed along the heat exchange pipe with a predetermined interval therebetween, and
the heat exchange pipe includes a filter installed thereon and configured to partition the inside of the housing into an upper chamber and a lower chamber, the filter configured to allow the refrigerant to flow through the filter between the upper chamber and the lower chamber.

20. A vehicle thermal management device comprising:
a radiator configured to perform heat exchange between coolant and air;
a condenser configured to perform heat exchange between refrigerant and the air;
a receiver dryer configured to remove moisture from the refrigerant discharged through the condenser, and to separate the refrigerant into liquid refrigerant and gaseous refrigerant; and
a heat exchange module connected to the radiator so as to allow the coolant to move therebetween, the heat exchange module configured to selectively perform heat exchange between the refrigerant in the receiver dryer and the coolant supplied from the radiator,
wherein the heat exchange module comprises a heat exchange part disposed inside the receiver dryer, the heat exchange part configured to perform the heat exchange between the coolant and the refrigerant.
